(19) United States
(12) Patent Application Publication
(10) Pub. No.: US 2009/0299906 A1
(43) Pub. Date: Dec. 3, 2009

(54) METHOD AND DEVICE FOR MEASURING SUPPLY AND DEMAND AND FOR OPTIMIZING VOLUME IN AUCTIONS AND REVERSE AUCTIONS

(75) Inventor: David C. Moshal, Mill Valley, CA (US)

Correspondence Address: HAYNES BEFFEL & WOLFELD LLP, P O BOX 366, HALF MOON BAY, CA, 94019, US

(73) Assignee: Optimal Markets, Inc., Sausalito, CA (US)

(21) Appl. No.: 12/129,592

(22) Filed: May 29, 2008

(51) Int. Cl. G06Q 30/00

(52) U.S. Cl. 705/80

(57) ABSTRACT

The technology disclosed relates to a practical design for measuring demand or supply in an auction or reverse auction, respectively for one or more divisible goods. It also relates to optimizing a volume selected by the auctioneer when closing an auction. In particular, it relates to a network based protocol and interface for conducting an auction with limited feedback to participants during the auction.

### BACKGROUND OF THE INVENTION

The technology disclosed relates to a practical design for measuring demand or supply in an auction or reverse auction, for one or more divisible goods. It also relates to optimizing a volume selected by the auctioneer when closing an auction. In particular, it relates to a network based protocol and interface for conducting an auction with limited feedback to participants during the auction.

In many situations supply and demand are difficult to determine from actors at widely disbursed locations who are guarding their own interests. Buyers and sellers are reluctant to invest the time to interact with a cumbersome interface or in circumstances in which they fear that their participation would be futile. They may give misleading answers to a badly designed data collection system, out of self interest.

A variety of problems are encountered in designing an auction system, including problems related to system performance/resolution and system rules. The system performance or resolution limits how quickly successive bidding rounds can be conducted and what protocols can be used. The system rules impact how forthcoming participants are.

Rules, implemented in software, have surprising impacts on participants in an auction. Network-based auction designs apply technology in ways that live auctions cannot mimic. The design and refinement of network-based auctions rests largely in the realm of experimental or behavioral economics. The unpredictability of human economic decision making has been recognized with the award of Nobel Prizes in Economics for work in experimental economics. Even basic theoretical developments in auction design, which underlie designs for FCC spectrum auctions, for instance, also have been considered remarkable enough for Nobel Prize recognition (Klarreich, Erica et al. “The Bidding Game” National Academy of Sciences, March 2003, pp. 1-9). The results of applying the latest network-based auction design to the Spring, 2008 US Federal Communications Commission auction of more than 1000 regional cell phone spectrum licenses surprised those involved: the $19.6 billion bid in this auction was reportedly as much as three times the predicted total of bids, even though the D Block of spectrum did not sell. SJ Mercury News, Business Section p. 2 (Apr. 16, 2008) available online at http://www.mercurynews.com//ci_{—}8942119?IADID=Search-www.mercurynews.com-www.mercurynews.com. The interaction between technology and auction design continues to hold great potential, given the surprising results of even the most closely watched auctions.

Bad design of auctions produces similarly unpredicted results: in one European spectrum auction, a bad design allowed one of two bidders for four licenses to signal with its bid prices which two licenses it wanted. The second bidder matched the first bidder's price for the other two licenses and the four licenses, giving both companies country-wide coverage, sold at public auction for only 80 million Deutsch marks total! See, Klarreich, supra, at 8.

Patents and publications by auction theorist Lawrence Ausubel in collaboration with others may be of interest as background. Four families of Ausubel patents and applications are represented by: U.S. Pat. No. 7,249,027, issued Jul. 24, 2007 entitled “Computer Implemented Methods and Apparatus for Auctions”; U.S. Pat. No. 7,165,046, issued Jan. 16, 2007, entitled “System and Method for an Efficient Dynamic Multi-Unit Auction”; U.S. Patent Publication No. 2007/0055606, published Mar. 8, 2007, entitled “System and Method for a Hybrid Clock and Proxy Auction”; and PCT Publication No. WO 02/42981, published May 30, 2002, entitled “System and Method for a Dynamic Auction with Package Bidding.”

An opportunity arises to improve on systems and interactions that elicit information regarding resource availability and pricing. Better systems that fairly elicit supply and demand curves from participants may result.

### SUMMARY OF THE INVENTION

The technology disclosed relates to a practical design for measuring demand or supply in an auction or reverse auction, for one or more divisible goods. It also relates to optimizing a volume selected by the auctioneer when closing an auction. In particular, it relates to a network based protocol and interface for conducting an auction with limited feedback to participants during the auction. Particular aspects of the present invention are described in the claims, specification and drawings.

### BRIEF DESCRIPTION OF THE DRAWINGS

FIG. 1 depicts interactions across a network between a server and participants.

FIG. 2 is a high-level block diagram of modules operating on a server.

FIGS. 3-5 depict a series of rounds in a session and possible responses from participants.

FIG. 6 is a high level flowchart of actions that may be combined to implement a session.

FIG. 7 is a block diagram of client components of a session manager.

FIG. 8 depicts one embodiment of software components, including an interaction component, queues and database.

FIG. 9 provides additional detail regarding optional actions that may be taken on the server to process individual participants during a round.

FIG. 10 provides additional detail regarding allocation at the close of the session.

FIG. 11 describes some alternative troubleshooting capabilities that optionally may be built into the system.

FIG. 12 depicts alternative rules for reporting round results to would-be participants.

FIG. 13 depicts a sample participant interface after multiple rounds of the session.

FIG. 14 depicts a sample auctioneer interface after multiple rounds of the session.

FIG. 15 depicts sample graphs that can be used to project supply or demand curves and predict outcome of an auction that has progressed through several rounds. Graphs of this sort can be used to enhance the auctioneer user interface or the observer user interface.

FIGS. 16-17 depict sample post-session reports that an auctioneer can provide to an auction sponsor.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

### Optimizing a Purchase Volume

The technology disclosed optimizes the volume of a good sold or purchased, while simultaneously optimizing the price and allocating the volume among buyers or sellers. For instance, a buyer of the chemical feedstock ethylene may sponsor an auction without knowing the price that she will need to pay. The buyer may desire to buy more at a lower price and may change her view during the auction, based on supply quantities and price points that are revealed. Much information is revealed by the auction technology disclosed below, which impacts the buyer's perception of value or willingness to pay a particular price. The auction may attract half a dozen or a dozen sellers. The technology disclosed has proven in live auctions of millions of pounds of ethylene to elicit reliable information that allows the buyer to subjectively optimize the volume purchased across a range of prices.

The terminology in this disclosure may be confusing to some who are regularly involved in markets that have a spread between bid and ask prices. One common use of “bid” and “ask” is to identify the highest price offered for purchase of an item and the lowest price offered for sale of an item. The “bid-ask spread” is the difference between bid and ask prices. This terminology does not readily apply to the auctions disclosed below, where the auctioneer sets a price (either for buying or selling a good) and the participants, sometimes called bidders, respond by offering a volume or quantity (either for selling or buying) responsive to the auctioneer's price. In this application, we use contract-oriented language of offer and acceptance. The auctioneer solicits offers by setting a round price and the participants make offers or bids by responding with a volume of the good that they would sell or buy at the auctioneer's current price. The price is set in the context of a minimum volume commitment by the auctioneer for buying or selling the good at auction. The auctioneer accepts the offers or bids are accepted at a particular round price when the auction closes. Applying the technology disclosed, the auctioneer typically applies a uniform price to offers from all participants or bidders.

An auction, as disclosed, is conducted using a computer-based platform. Generally, the auctioneer controls the auction and the participants respond to the auctioneer's pricing, using their respective computers. This pattern can be varied for an occasional bidder who has communication problems, by talking the participant through what appears on the screen and entering data on the participant's behalf, using the same interface that the participant would otherwise use. The auctioneer's round price changes in successive rounds, either rising in a seller's auction or dropping in a buyer's auction. We call the computer-to-computer connection, as distinct from the auction, a session or an auction session. The terms auctioneer and auction sponsor may be used interchangeably, even though the roles may be assigned to two people who work closely together during the auction.

The auction server communicates across a network with participant terminals or computers representing many participants. Enhancements of the auction server performance are directed to minimizing lag time in communications with participants. In addition, latency in network communications may be monitored by the system, as an auction proceeds. Measurement of latency can lead to intervention during the process, if a participant seems to be losing their connection. After a session, the auctioneer may communicate with an impacted participant to encourage an investigation of their network performance.

The server typically sends out a module that can be run on the participant terminals during an auction. This module can be hosted by a web browser, or it could be a standalone module. Distribution of the module may be close to the auction time or in advance. The module provides an interface for auction rounds. During a round, the interface informs the participant of the current price, the most recent relationship of bids to an auctioneer's minimum commitment or a bidder's initial eligibility, and the participant's comment volume eligibility. The interface should provide a timer that counts down to show the approaching end of a round and a messaging window that allows private communications with the auctioneer. In one embodiment, the server and network latency is small enough to implement the round countdown timer as a message window and to have the server broadcast discrete times as messages (e.g., second-by-second) to be displayed by the countdown timers. This avoids issues of synchronizing clocks on auctioneer and participant machines. The messaging window also may receive broadcast messages from the server auctioneer to all participants.

In one embodiment of the server platform, messages between the server and participant are written to and read from message processing queues. A database process records the progress of events. The sessions do not rely on the database for information to distribute to the server auctioneer or to the participants. Relying on database queries to provide updated information about an auction in progress is prone to generate unacceptable lag times. That is, if a database hosted by a database server were relied upon to produce data in response to participant requests for end of round results, noticeable and confounding delay could result. In some architectures, separate retrievals of data for each time the participant modules were updated with data could make it difficult to process submissions to the auction as the time clock for a round approached zero. Instead, queues hold the information needed to conduct the session.

In an alternative embodiment a high reliability, embedded in-memory database could be used to deliver quick responses. One such an in-memory database is eXtreme DB, available from Mc______.com.

An intelligent interface design and network-implemented protocol encourage participation in a session that elicits granular supply and demand data. In practice, round-by-round price increments of one-eighth of a cent for a 50 cent per pound product have proven to be practical and participants have continued to bid through more than a dozen auction rounds. Some auctions using the technology disclosed have achieved price granularity in the range of one-quarter percent to one percent of the product price in six or more successive rounds. Other auctions have used changing price increments to cover a broader price spectrum, to cover a price range of ten to 30 percent of the final price. Contrary to notions of private values, experience shows that limited feedback to participants on the level of competition in the auction strongly impacts their behavior. Sample interfaces for participants are depicted in the figures.

The participant interface is straightforward, clean and reliable. It includes at least a current round price, a demand indicator (after a first round), a quantity eligibility, an indication of time until the end of the round, a control used to enter a quantity bid and a trigger to send the bid. It also may include a messaging window. The messaging window handles private communications from participants to the auctioneer and broadcasts from the auctioneer.

The control used to enter a quantity bid may also accept a revised bid that can be submitted to correct a mistake. Alternatively, a messaging window can allow a participant to explain a mistake to the server auctioneer and request an alternative bid. A history of the participant's bids and of demand indicators is useful for a participant to see.

The auctioneer interface provides control over round timing and pricing. It allows the auctioneer to close the auction and permits limited overrides to be exercised consistent with pre-announced rules. The server may support an observer interface that repeats the information visible to the auctioneer.

After a round, the participant interface is updated with a masked indication of the level of bid quantities. This has proven to have a significant impact on auction conduct. It has been observed in actual auctions that, when the participants receive an indication at the start of a two or three minute long round that a high volume was bid at the prior round price, the participants behave differently than if the indication is that there was low quantity offered.

This inventor believes that auction theorists who posit a so-called “private value” of a good are mistaken, at least for ethylene. Much of auction theory assumes that participants have a private value for a good that is being auctioned. Many auction theorems depend on assumptions about economic behavior to predict resulting strategic behavior. For instance, notions of private values have led various theorists to propose proxy bidding, where private value information is encoded and submitted to software that acts on behalf of the bidder with expedited processing.

This inventor's experience is at odds with the theory of “private values” and more in line with so-called prospect theory. See, e.g., Daniel Kahneman, Amos Tversky, “Prospect Theory: An Analysis of Decision under Risk”, Econometrica, Vol. 47, No. 2 (March 1979), pp. 263-292, doi: 10.2307/1914185; Daniel Kahneman, “Maps of Bounded Reality”, Les Prix Nobel, The Nobel Prizes 2002, Editor Tore Frängsmyr, [Nobel Foundation], Stockholm, 2003 accessed Apr. 4, 2008 at http://nobelprize.org/nobel_prizes/economics/laureates/2002/kahneman-lecture.html; “Prospect Theory” at http://prospect-theory.behaviouralfinance.net/accessed Mar. 28, 2008. Prospect theory brings psychology into economic analysis, by describing how decisions actually are made, instead of prescribing how they should be made. As relevant here, this inventor's experience is that participants who bid a quantity at a current round price have a stronger personal attraction to holding onto their current volume share of a promised transaction than rational economists would predict. This inventor's experience includes observing that a masked indication to bidders of the level of competitiveness in the bidding (e.g., a low, medium or high volume of bids, when gauged against the minimum commitment of the auctioneer or the initial eligibility of a bidder), measured at the end of a round and reported before the next round begins, has had a real and observed impact on bidding.

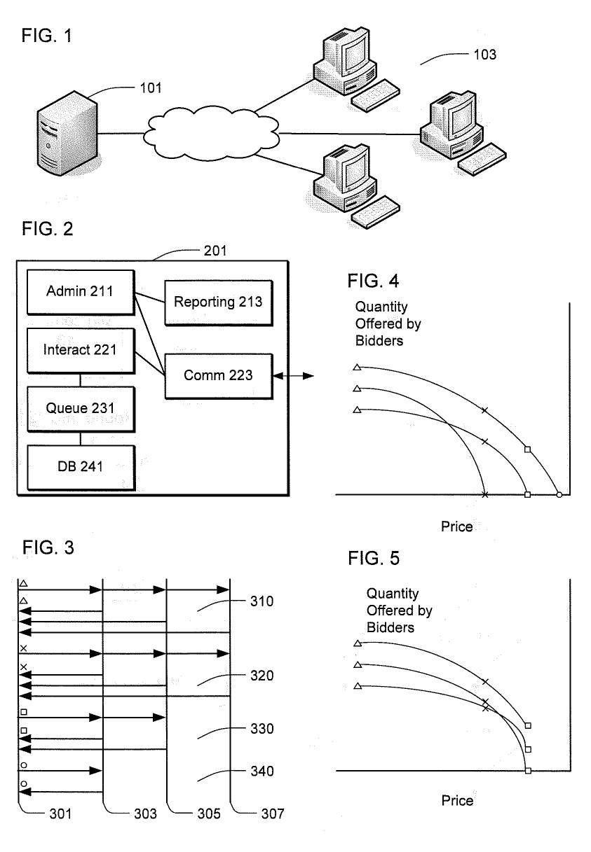

FIG. 1 depicts interactions across a network between a server and participants. In one embodiment, this interaction remotely senses the availability of resources in response to stimulus from the server. In another, the server remotely senses that demand for resources. The server 101 is connected via a network, such as the Internet, to multiple participants 103. Interactions between server and participants are designed to enhance the information about supply or demand that is collected by conducting the session expeditiously and with a clear user interface that encourages full participation.

The basic unit of interaction is an auction. Within an auction there are multiple rounds. Across multiple auctions, the behavior of participants can be influenced by an historical pattern of auction closing behaviors. In a series of auctions, the auction closing behavior in the last few or most recent auctions, for instance the last five or seven auctions, may strongly impact participant behavior.

FIG. 2 is a high-level block diagram that depicts one embodiment of modules operating on a server 201. The server and the network to which it is connected preferably are enhanced for reliable and relatively low latency interactions. Because rounds in an auction run quickly, momentum in the auction can be lost if network unreliability causes restarting of rounds or reconnecting users. While the server supports restarting rounds and reconnecting users, these measures detract from the speed with which an auction progresses through rounds.

Within the server 201, communications module 223 communicates with participants. The communications module typically communicates through a network interface and across a network with participants. An administrative module 211 handles registration of participants and also may handle initial eligibility quantities. The administration module also may give the server auctioneer or auctioneer access to a reporting tool 213. The participant interaction module 221 handles interaction with participants at session setup, during rounds and at session closing. The interaction module utilizes the communications module 223.

The queue 231 represents one or more in memory data structures that reduce latency during interactions with participants. One use of the queue and a multi-threaded architecture, is to queue messages for communications with participants. These messages may include chats, broadcast messages, auction-related messages and round-related messages. Queues for incoming and outgoing messages may be separately maintained. Another use of the queue may be to persist auction records to nonvolatile memory. It is useful to permanently record interactions during an auction. However, especially with larger numbers of participants, basing updates to participants on responses to database queries tends to introduce an indeterminate latency. Use of a queue 231, allows a database module 241 to independently or asynchronously persist auction interactions to disk memory or other nonvolatile memory, while request processing logic prepares incremental updates for participants.

The interaction module 221 and/or communications module 223 preferably conduct a series of handshakes with participants. These handshakes may simply be a matter of accessing transport layer acknowledgments or they may be implemented at the application layer. In one embodiment, client modules running on participant terminals poll the server regularly. These modules measure the server's response to polling messages and report the measurements in a subsequent message. The server responds to the polling requests by checking the outgoing message queue and forwarding what it finds, if anything. Alternatively, the server could send out a regular heartbeat message and measure time that it takes for the participant modules to respond. The handshakes during a session verify that a participant is still connected and allow measurement of latency. In one auction, the measurement of latency led to the discovery of a very awkward routing of packets within a corporate network that resulted in communication latencies of several seconds. Such latencies work to the disadvantage of a participant who tries to time their response against a countdown clock (even though the design disclosed herein does not allow one participant to affect another participant's behavior or success by timing their response.)

FIGS. 3-5 depict a series of rounds in an auction and possible responses from participants. In FIG. 3, the server 301 is in communication with three participants 303, 305, 307. The initial round 310 is indicated by a triangle. The server initiates communications with all three participants. In turn, the participants provide information regarding resource availability or demand. In other words, participants offer to sell a certain volume or offer to buy a volume in response to the auctioneer's a price for the round. Two scenarios are depicted in FIGS. 4 and 5. In both FIGS. 4 and 5, all three participants offer a quantity for sale at a first-round price. As rounds progress to the right, the auctioneer's price drops. In FIG. 3, the second round 320 is indicated by an “X”. The server again communicates with all three participants, who return bids. In one scenario, depicted by FIG. 4, one of the participants offers zero quantity at the second round price, while the other two participants offer positive quantities. Accordingly, in the third round 330, signified by a square, the server needs only to solicit bids from two of the three participants, because one participant's eligibility was reduced to zero by its second round bid. FIG. 4 depicts a scenario in which a second participant offers zero quantity at the third round price. Assuming that the quantity offered by the remaining participant is at or above the minimum purchase guaranteed by the auctioneer, the fourth round 340 is conducted. This round is signified by a circle. Of course, auctions need not go four rounds or they may continue for many more rounds. In FIG. 5, a three round auction is depicted. In the third round, one of the participants offers zero quantity. This auction stops after the third round.

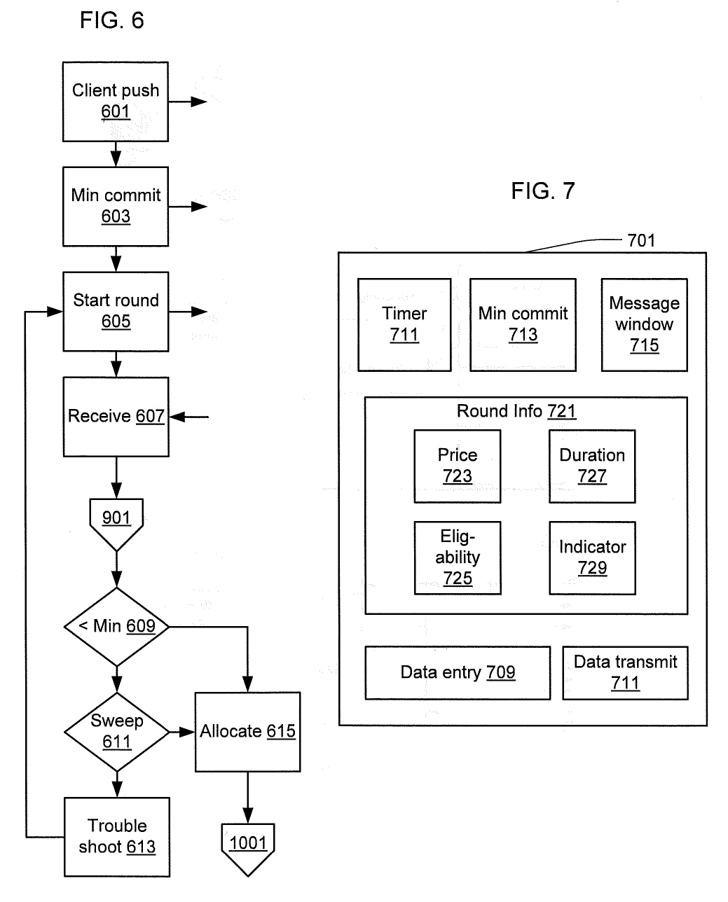

FIG. 6 is a high level flowchart of actions that may be combined to implement a auction. Some of the activities may be separate from the auction, for instance, participant registration for multiple auctions. Because the technology disclosed measures supply or demand of participants 103 at a variety of prices, there is utility to inducing participation and remotely measuring supply or demand, even before bids are accepted. An auction session is useful for measurement of supply or demand after even just two rounds, before the auction closes.

In FIG. 6, a user interface client is sent 601 from the server to one or more participants. This interface client, with which may sometimes be called an auction manager, may be pushed from the server to the participants or pulled by the participants from the server. The client may use the Flash infrastructure from Adobe and the Flex programming environment, or it may use a variety of other programming constructs It will be understood that Flash typically runs in a browser environment, but recently has been enhanced to generate standalone modules other browser-based technologies include HTML/JavaScript and Java applets. The client, alternatively, could be a standalone program or a program with an embedded browser. An auction manager could remain resident on a participant workstation for multiple rounds.

A minimum commitment is sent 603 from the server to the participants. In a buyer's auction, this would be a minimum purchase commitment. In a seller's auction, this would be a minimum quantity that would be sold according to a price set during the auction. Preferably, this commitment is sent to clients running on participant systems and is visible to the user during the auction. Alternatively, it could be transmitted via a separate message channel and known to human participants but not reiterated in the auction user interface. The minimum commitment prevents the auctioneer or other party in control of the auction from reducing the quantity at auction in an effort to manipulate the price. Transmitting the minimum commitment from the server to the participants' systems has proven in actual auctions to enhance user participation and to instill participant confidence in the auction process. In a buyer's auction, for instance, the minimum commitment approach assures sellers that a meaningful quantity will be purchased at prevailing prices. This inventor's experience is that participants are satisfied with a minimum commitment and an actual volume that exceeds expectations. It has been surprising to see how much more successful auctions are when the auctioneer has flexibility to increase volumes in response to favorable pricing than auctions were when the auctioneer exercised an option to decrease volumes in response to unfavorable pricing.

A so-called minimum commitment allows the party controlling the auction to buy or sell more than the minimum at a stated round price, instead of conducting more rounds. If the auctioneer subjectively determines that it would be better to select a volume greater than the minimum commitment, the minimum commitment rule allows the auctioneer to do so.

The minimum commitment rule disclosed runs against suggestions made by a preeminent auction theorist to use a volume reduction rule, which permitted the auctioneer to set an initial target quantity but to reduce the quantity in pursuit of more favorable pricing. In 2005, this inventor ran four auctions for a client who was selling goods. In the first two, international and local players were invited to the seller's auction. The international players could only receive 15 million pound ship loads of product. Local players were allowed to bid in multiples of 1 million pounds. The volume for sale was set at 15 million pounds, to allow the international players to participate. Consequentially, the first round quantity eligibility of participants was limited to 15 million pounds each.

However, only the local players placed bids in the first two auctions and their combined bid quantities were at or barely above the initially established auction quantity. These auctions lasted only a few rounds each and produced poor results for the seller. This inventor consulted with a preeminent auction theorist, who recommended using a volume reduction rule. According to the volume reduction rule, the auctioneer was allowed to reduce the auction volume by announcing at the beginning of an auction round that a smaller quantity was now for sale. The auction quantity became a moveable target. This produced poor results. Each time the auctioneer announced a smaller quantity for sale, the participants retaliated by reducing their bid volumes. Two auctions were run using the volume reduction rule during 2005 and both were relatively unsuccessful. This inventor believes that exercise of a volume reduction rule, in the practice, undermined the incentive for participation to the long-term detriment of the auction process, particularly when the auctioneer reduced the volume repeatedly during an auction.

The minimum quantity commitment rule disclosed herein is consistent with Prospect Theory, because of the way in which it establishes a zero point for participant expectations. From the zero point, a volume reduction runs into the steep part of the negative utility slope posited by Prospect Theory. That is, application of the volume reduction rule sharply decreases participants' utility of being involved in the auction. From the zero point, a transaction that exceeds the minimum commitment produces a favorable impression on participants. Again, this asymmetry is such an important deviation from the teachings of rational economics that the psychologists who formulated Prospect Theory were awarded a Nobel Prize in Economics.

Moreover, the auctioneer's minimum commitment typically is set low enough to mask the auctioneer's true supply-demand situation, while still meeting the participants' need to have a meaningful volume outcome. Typically, the minimum commitment has been one-fourth to one-half of the volume that the auctioneer would be willing to accept, at the right price. Most auctions have resulted in the auctioneer selecting an auction volume that exceeds the minimum commitment. This gives the auctioneer substantial opportunity to subjectively optimize or to choose the volume exchanged at the close of the auction.

Rounds are conducted iteratively. The server 101 starts a round 605 by sending one or more messages to participants. The messages include at least a round duration, a round price and a participant's own eligibility to bid in the round. In rounds after the first round, the messages may also include an indicator of bid quantity activity. With the start signal, the round duration counts down. Using the technology described, rounds can be conducted quickly. The duration for a round of three minutes has been used effectively in ethylene auctions. Based on experience, a duration of two minutes is practical. For experienced participants, the duration of 30 to 90 seconds should work in ethylene and similar auctions. The auction interface shows the round-by-round change in price and includes a masked indication of bid volumes at the end of a round. Even an experienced participant needs some time to become comfortable with the progress of the auction and to revise their strategy. This time to think can be during a round or between rounds. The interface makes it practical for a user to enter or select a bid quantity in only a few seconds. Because the quantities in an ethylene auction are typically millions of pounds and the bid increment is a million pounds, it is expected that a practical minimum time for a round will be at least 10 seconds between rounds and 30 seconds duration of a round. In experience, an auction round for petroleum products that lasts longer than five minutes discourages participation and may even allow enough time for market conditions to change during the auction. For some goods, the duration of a round could be reduced to as little as two seconds. The time between rounds also could be reduced to as little as two seconds. A combined round and between-round time of 5 to 15 seconds may be achieved for some goods. In fast-moving rounds, user interface might require reconfirmation of the participant's position in the prior round or it might assume that the participant's position was unchanged unless the participant used either the time between rounds or the in round duration to modify their prior position. The time between rounds and the in-round duration may be traded off, as long as the auction manager has time to decide whether to proceed to the next round and participants have time to react to the new round price and respond accurately.

The quantities bid indicator masks the actual quantities bid and is designed to trigger in human participants an expectation as to how many rounds are likely to remain in the auction. With a pattern of price changes that is either preannounced or which comes to be expected from experience, a number of rounds remaining in the auction roughly translates into a final auction price. For instance, in the second round, if the minimum purchase commitment were 5 million pounds and the bid quantities totaled 20 million pounds in a buyer's auction, the indicator would signal “high” to indicate that substantially larger quantities were bid than the minimum commitment. The participant might estimate that the indicator suggests that there will be at least three more rounds in the auction. If a price decrease of ⅛ of a cent per round is expected, that would mean a price decrease of ⅜ cents over three rounds. In practice, indicators of “low”, “medium”, and “high” have been successfully used. These indicators have been given predefined meanings before or at the start of the auction. The predetermined meaning of these quantities may be chosen to relate to either the minimum commitment or the first-round eligibility of participants. When the first-round eligibility for participant exceeds the minimum commitment by a factor of three, it may be desirable for the “high” indicator to be set at a predetermined level that reduces the likelihood that a single participant would trigger a high indicator. More than three indicators may be desirable when the initial eligibility is a higher multiple of the minimum commitment.

A masked indicator is preferred to an actual statement of total bid quantities. It is believed that an actual statement of total bid quantities would encourage participants to engage in strategic behavior that either would signal other or would not reveal their actual supply or demand curves. For instance, if initial eligibility were three times the minimum commitment and there were four participants, one participant might always use their maximum eligibility at the initial price to confuse the other participants or to signal when bidding should stop. As indicated above, prices in multi-unit auctions of cellular spectrum have been used to signal from one participant to another a suggested final price, to the great disadvantage of the auction sponsor. In practice, the masked indicator has prevented intimidation and signaling through the system.

Messaging from the server to participants may depend on whether a particular participant has any remaining eligibility. This is more fully depicted in FIG. 12.

During a round, messages are received from participants 607. The messages include at least bid data from participants. The messages preferably also include handshake or keep alive data that verifies the connection between the server and the participants and that measures latency. In practice, increasing latency has been associated with a likelihood that a connection will fail.

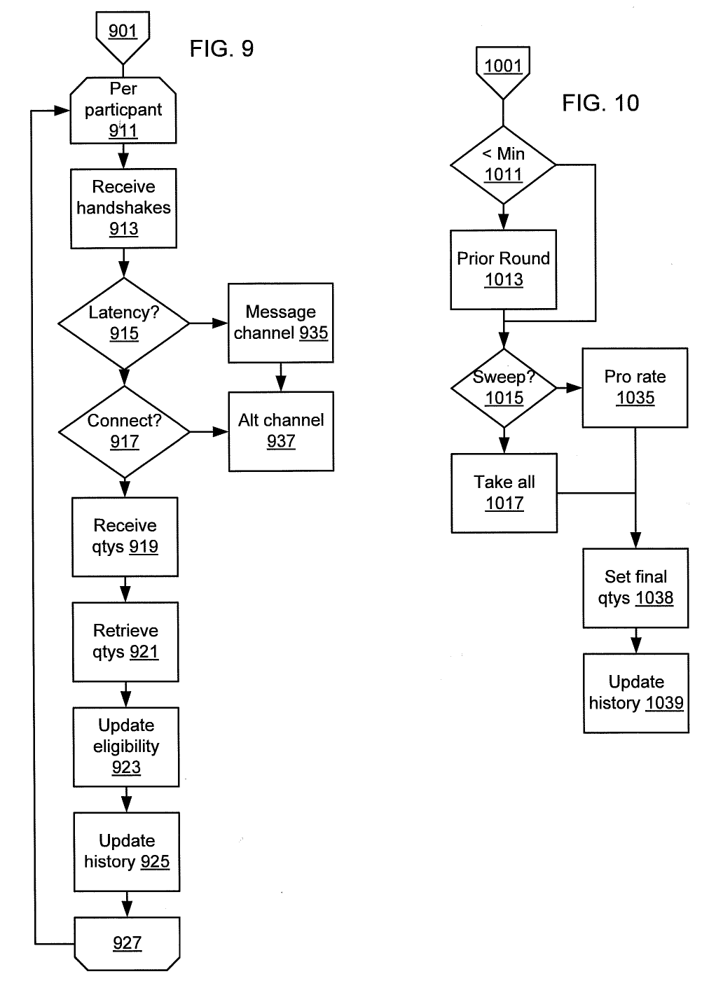

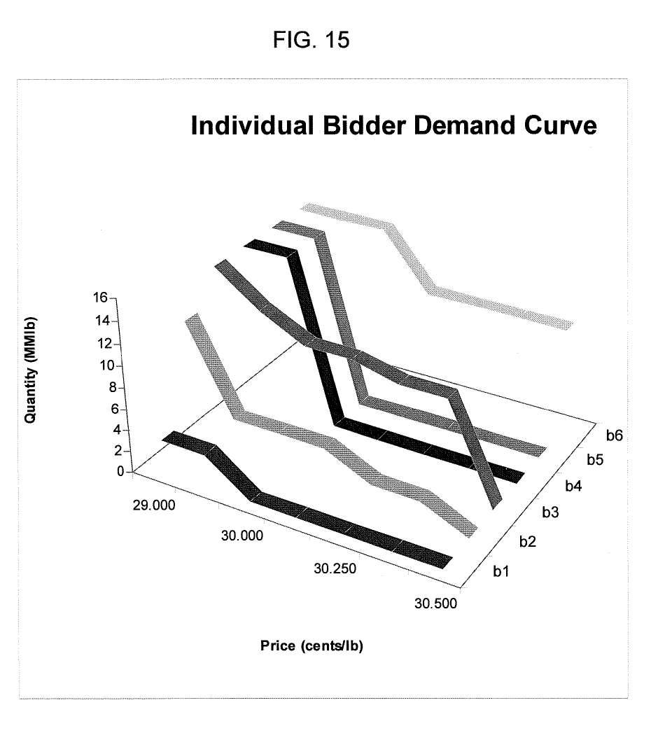

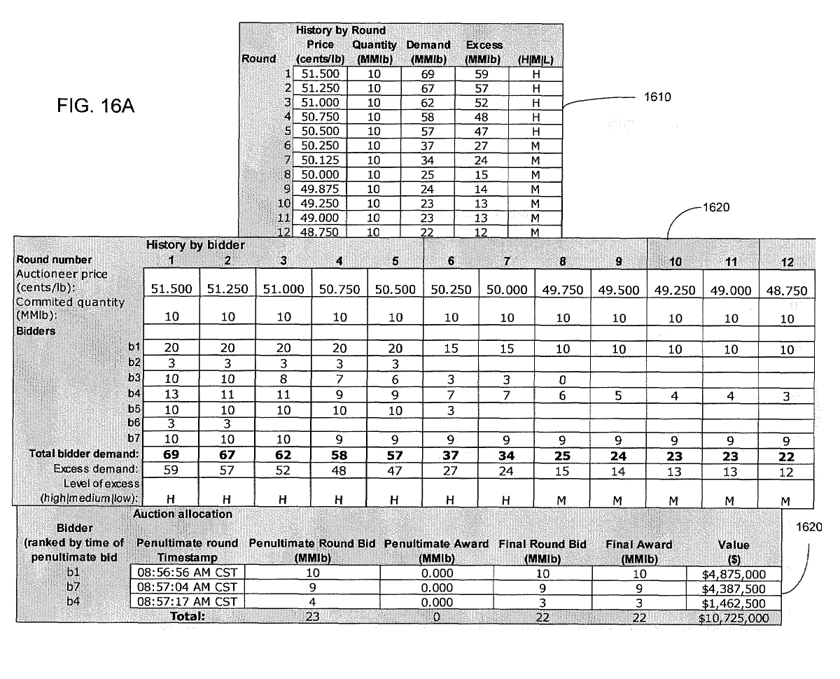

A variety of analyses can optionally be performed during a round, as depicted in FIG. 9-12. During a round, the system determines 609 whether the sum of all bids is less than the minimum commitment for purchase (in a buyer's auction) or sale (in a seller's auction.) When this condition is reached, the rules dictate that the auction ends. The final price reverts to the round price before the terminating condition was reached, the price in the so-called penultimate round. A uniform price is set and the quantity is allocated 615 among remaining participants. The allocation 1001 is more fully described in FIG. 10. If the quantity is greater than or equal to the minimum commitment, a human participant controlling the server decides 611 whether to conduct another round on more favorable price terms. This decision allows the human participant to subjectively optimize the volume at the end of the auction. The human participant has at least the history of bids available and also may have curves produced by the server that project a trajectory of bids, as illustrated in FIG. 15. The rules may allow the auction to close and proceed to allocation 615 by sweeping all participant bids for the round or by selecting a volume greater than or equal to the minimum commitment and less than or equal to the total of all participant bids.

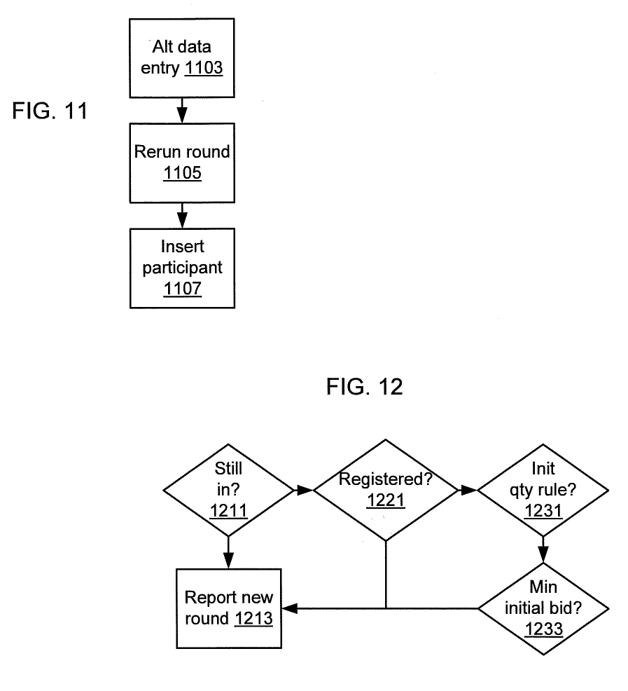

Optionally, the auctioneer may troubleshoot 613 a particular round before starting the next round. This troubleshooting may happen at any point in the process; it is not restricted to immediately preceding the start of a round. Trouble resolution options are more fully depicted in FIG. 11.

A round that does not result in closing and allocation 615 or troubleshooting 613 iterates through the start of a subsequent round 605.

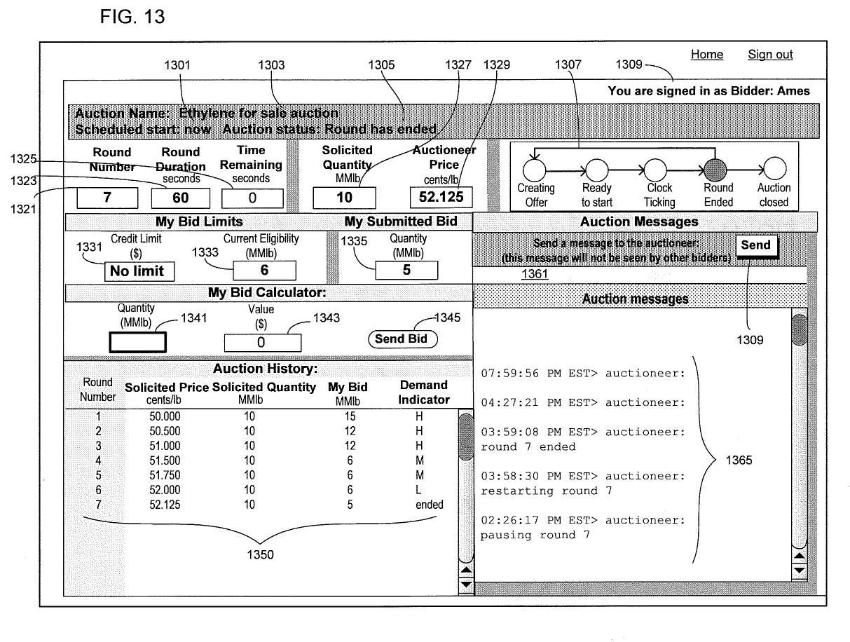

FIG. 7 is a block diagram of client components of one embodiment of an auction manager 701. One illustration of a corresponding participant interface appears in FIG. 13. A timer 711 indicates the remaining time in a round. Preferably, the time displays a time message that is regularly updated by the server. Alternatively, a participant's clock on the participant's computer can be synchronized with a server clock. The timers are reset in between rounds. Preferably, a minimum commitment for the auction 713 remains visible as part of the user interface. However, it could be presented in a separate message. A message window 715 is useful for private communications between the auctioneer and a particular participant and for general broadcast messages from the auctioneer to the participants. Preferably, the message window does not allow private communications among participants, which could be used for collusion or intimidation.

Information regarding a particular round 721 includes price 723, eligibility 725, duration 727, and a masked indicator of prior round results 729. The price changes monotonically in one direction, down for a buyer's auction and up for a seller's auction. The eligibility 725 begins with an initial eligibility quantity or volume and remains constant or decreases, depending on choices the participant makes in successive rounds. In a buyer's auction, for instance, a selling participant can monotonically decrease the quantity that they offer for sale as the price decreases, but can never increase the quantity for sale above the quantity offered in the preceding round. The duration 727 of a round may be the same throughout an auction or may vary. A first or preliminary round may be added to the design to test connections of participants and bona fide participation. This sort of first-round may be longer than subsequent rounds. The round duration may be indicated by resetting the timer 711 before it starts counting down. Alternatively, a preliminary sign-in period could precede the first round. The masked indicator 729 is used in second and subsequent rounds to give participants feedback regarding total participation in the prior auction round. In one embodiment, price, eligibility, data entered and the indicator may be shown to the participant as an organized history of their participation.

A control for data entry 709 is provided. This control may be a blank to be filled in, a series of radio buttons that a participant can select, a dial that the user turns, a slider that the user adjusts, or a combination of a blank and a graphical alternative. The data transmit button 711 optimally may be provided. With many user interface technologies, the data transmit button 711 is unnecessary, but it is reassuring to the participant and reduces the chance of a bidding error.

The client 701 also may include a state transition diagram that depicts the current state of the session in an easily understood, graphical form. One graphical form that depicts the status of a round appears in FIG. 13, which is described below.

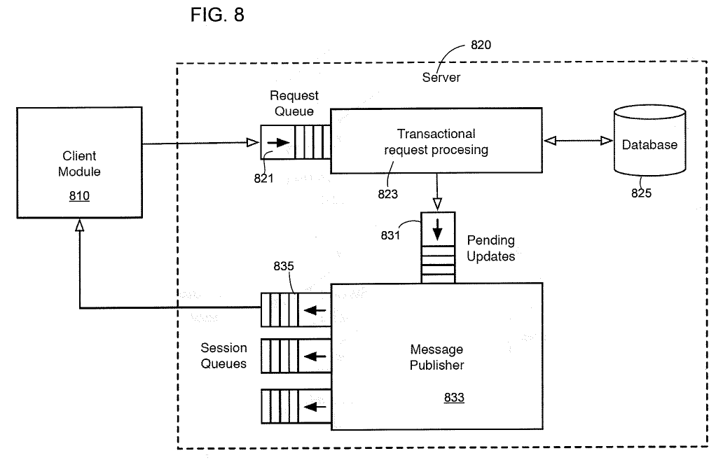

FIG. 8 depicts one embodiment 801 of components from FIG. 2. This embodiment innovates on the server architecture described by Welsh, Matt, David Culler, and Eric Brewer. “SEDA: An Architecture for Well-Conditioned, Scalable Internet Services.” SIGOPS Oper. Syst. Rev. 35.5 (2001): 230-43, which is hereby incorporated by reference. A client module 810 is distributed to participants. The client may be an HTML and JavaScript application based in a browser or may be written in a form-oriented, browser-based language, such as the Flex variation on Flash. It could be written as a Java applet. In one embodiment, the client module maintains two connections to the server 820. One connection is with the server's request queue 821 and the other connection is with one of a plurality of session queues 835. Connection between the client and queues may be mediated by appropriate connection handlers.

The client or participant 810 sends a request to the server 820. In traditional web applications, clients pulled data from the server. In this embodiment, a request mechanism is used to send commands to the server, but not to receive data. The commands are placed in request queue 821. Each request is processed from the queue in the order received. The transaction request processing module serializes the requests. The request processing results in a change to the application state, which is persisted to a database 825. The changes to the application state also are sent to a pending update queue. If the database does not throw an exception, the pending updates are flushed to the message publisher module 833. For efficiency, it is practical to send out only updates, changes or differences in what will be displayed, without sending out refreshes of the entire display for the participants and/or the auctioneer. The message publisher module 833 determines which client modules 810 should receive updates. The message publisher places pointers or indexers to update messages in client session queues 835. In this embodiment, each client has its own session queue. In some embodiments, the messages published at the session queues include updates to the countdown timer. In this manner, the countdown that appears on the screen a particular client module depends on continuing communications between the client module 810 and the server 820 and not on any local function of the bidder's system clock. The client module, using a session connection to the server, may poll the server twice or more often per second, for instance each 400 ms. With the polling running at twice the minimum time resolution shown on the participant interface clock, the message publisher module 833 can send out each tick of the auction clock, thereby avoiding issues of synchronizing client and server clocks. The alternative implementation is to use a network time protocol. Other information of interest to the client or participant also can be placed on the session queues. Typical information is depicted in FIG. 13. An alternative embodiment of the second connection between the client module 810 and the session queues 835 is to keep an open connection between the client and server and to push data through the connection, rather than responding to polling requests. Sometimes, the term “Ajax comet” is used to describe maintaining an open connection and pushing data through the connection to the client.

Alternatively, the transaction processing and message publisher modules could be combined in a single module. Following this alternative, a tight, fast architecture would process requests (i.e., bids and messages) to generate updates while a parallel processing or multi-threaded architecture would pass updates to a plurality of participant and auctioneer client modules.

This architecture trades increased storage space for reduced latency. Instead of having each client query a database for changes, memory is allocated for client queues. Polling the database in response to user requests could, for large numbers of clients, result in substantial latency. Accordingly, this architecture determines the changes, updates or deltas that are responsive to incoming requests and places only the deltas on the session queues 835. These deltas are read-only (immutable) queue entries, so multiple, parallel threads of execution can take messages off the session queues. The operating system can be allowed to determine the optimal number of threads to service the queues. Multicore machines can take advantage of multiple threads running on individual cores. In one variation on this architecture, the polling requests to the session queues may carry latency-related information and report and the last queue entry serviced. The latency-related information may, for instance, include a measurement made by the client module 810 of the round-trip time for the last polling request and/or a rolling average of recent round-trip times. The message publisher may update the auctioneer's interface with this information, from time to time, either on a regular reporting or an exception basis. The polling requests also may include a sequence number for the last queue entry serviced. Including in the polling protocol such a sequence number would allow threads that manage the session queues to operate statelessly.

FIG. 9 provides additional detail regarding optional actions that may be taken on the server to process individual participants during a round. Processing during a round is signified by the iteration between 911 and 927. Optionally, but preferably, the server and participant systems exchange handshakes 913 throughout a round. The server or the client module, as described above, can monitor the round-trip time between transmitting and receiving a message and may report latency to the auctioneer.

Latency may be compared to a predetermined standard 915, with an alert to the auctioneer when the latency exceeds this predetermined standard. Alternatively, raw latency numbers or a meter bar can be used to inform the auctioneer of current latency. A meter bar that goes from green to yellow to red, as used in recording software for volume levels, may provide a useful visual display to the auctioneer. If latency is excessive, the notification may be generated 915 for display in the message window 715 of the participant workstation session manager 701. This notification may be generated automatically by a diagnostic module. It may be sent automatically or with approval from the auctioneer. Alternatively, the auctioneer may manually generate an appropriate message. If messaging via a message window 935 is unsuccessful, the auctioneer may initiate a telephone call or otherwise use an alternate channel 937 to communicate with a lagging participant.

The system immediately brings a lost connection 917 to the attention of the auctioneer. Typically, the auctioneer will initiate communications using an alternate channel 937, such as making a telephone call or sending a text message. For more detail regarding recovery from communication errors, see the discussion below of FIG. 11.

FIG. 10 provides additional detail regarding allocation at the close of the session. The manner of allocation depends on whether the total quantity bid has crossed the minimum commitment threshold. If the total quantity offered for sale in a buyer's reverse auction, for instance, has dropped below the minimum purchase commitment, the auction backs up to a prior round 1013 in which the quantity offered for sale equaled or exceeded the minimum purchase commitment, to the so-called penultimate round. That is, each of the participants is required to stand by the quantity that they offered in the prior round. Similarly, if the total quantity demanded in a seller's auction has dropped below the minimum sale commitment, the auction backs up to the prior round.

If the quantity exceeds the minimum commitment, the auctioneer decides whether to stop the auction and honor the minimum quantity commitment, “sweep” the whole quantity offered by participants in the round, or choose an intermediate quantity between the minimum and the sweep. In some embodiments, the auctioneer will limit herself to selecting either the minimum commitment quantity or a sweep, when they stop the auction while offers still exceed the minimum commitment. When the auctioneer sweeps the available quantity, all offers are accepted 1017. Otherwise, quantities from participants are pro-rated to meet either the minimum commitment quantity or the intermediate quantity. Pro-rating may be adjusted to rounded lots for measurement or shipping convenience or the system may constrain the auctioneer to select a quantity that is easily apportioned in rounded lots. The system sets final quantities 1038 for transactions with each of the participants. Either directly or asynchronously through a queue, the system updates history records.

FIG. 11 describes some alternative troubleshooting capabilities that optionally may be built into the system. Alternative bid entry modes 1103 may be used by the auctioneer either for participants who require special accommodation or for participants who are experiencing network difficulties. Re-running a round 1105 is an alternative to auctioneer entry on behalf of a participant. For instance, a participant who experiences network failure for a few seconds at the end of a round may request that the round be rerun so that they can enter their quantity. A third useful troubleshooting capability is to insert a participant after the first round has begun or closed 1107. This is useful when a participant has trouble connecting or is tardy. For instance, a participant may believe that their session manager client software is up-to-date, but find that they must download a new client, thereby missing the start of the session. The auctioneer has the option of adding the tardy participant as a troubleshooting measure. Another troubleshooting option is to accept a tardy bid.

FIG. 12 depicts alternative rules for reporting round results to participants based on eligibility criteria. Three alternative eligibility rules distribute information about the progress of the auction to participants based on different levels of participation. The rules may affect auction visibility to participants who log in for the first round, to participants who offer to buy or sell at least a minimum volume during the first round, or to participants who continue to meet a minimum volume threshold on a round-by-round basis. In FIG. 12, the first test 1211 is whether the participant continues to meet at least a minimum offer volume threshold for a current round. The second test 1221 applies a rule that permits viewing of round results by anyone who logged in for the first round. The third test 1231 is whether a first round quantity test applies to permit viewing by anyone who made at least a minimum offer volume during the first round. The order in which these tests are applied can be varied without changing the result or a case statement can be used to select just the test applicable to a particular auction. If the applicable test is satisfied, the results for the most recent round are published to the participant. Eligibility tests are applied to individual participants, unless the rule is that all participants who are logged receive full information throughout the auction. These rules may apply to reporting final results, to reporting interim results, or to both.

FIG. 13 depicts a sample participant interface after multiple rounds of the auction. The auction has a descriptive name, such as “ethylene for sale” 1303. The name of the bidder or participant may be given the upper right-hand corner 1309. Status information may be redundantly given in text 1301, 1303 and a graphic state transition diagram 1307. The state transition diagram can be implemented as four picture messages that are alternatively displayed. Information regarding a current round is given by round number 1321, round duration 1323, time remaining 1325, solicited quantity 1327 and current round price 1329. The solicited quantity 1327, according to the design disclosed herein, is a minimum commitment that does not change during the auction, which the auctioneer may decide to exceed when closing the auction. Data regarding the particular bidder or participant is given as a credit limit 1331, a current eligibility quantity 1333 and a most recently submitted bid 1335. The credit limit is optional. When the auction round is in the “clock ticking” state, the bidder or participant may enter a quantity 1341, and automatically see an extended price 1343, based on the current round price 1329. The bidder may register their bid by pressing the send bid control 1345 or the system may automatically register the quantity indicated. After the user sends their bid, the submitted bid display 1335 may be updated. The bidding panel 1341-1345 may be replaced by another kind of control, such as a series of radio buttons, a slider or a dial. Alternative bid entry controls may minimize the chance of typing mistakes, especially the chance of entering the wrong number of zeros. The auction history panel 1350 includes a row for each round in the auction. The solicited price is the auctioneer's price 1329 for the round. The solicited quantity remains unchanged, in the design disclosed in this application. “My bid” and the participant's eligibility are monotonically constant or decreasing, starting from an initial eligibility volume that optionally may exceed the solicited quantity. The mask demand indicator, in this example “H”, “M”, or “L”, gives the bidder an idea of how much interest there is among other bidders. In the embodiment shown here, the bidder does not know how many bidders are participating or who they are. The bidder only knows approximately the total quantity of bids in the preceding rounds. In the last round, either a closing message such as “ended” or a demand indicator can be displayed. The auction message panel permits communication from a bidder to the auctioneer and from the auctioneer to bidders. A bidder may type in a message 1361 and send it to the auctioneer 1363. Messages among bidders are not supported by the interface and may be prohibited by auction rules. A history of auction messages displayed 1365.

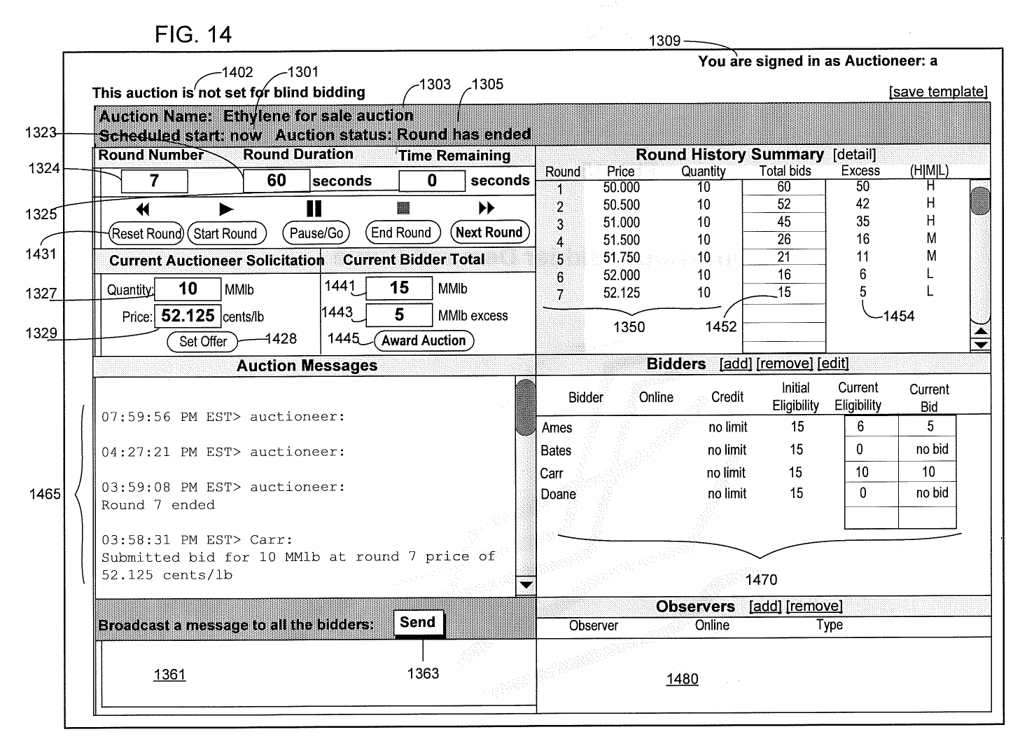

FIG. 14 depicts a sample auctioneer interface after multiple rounds of the session. The auctioneer interface shares many of the features of the participant interface. Shared features are identified using the same reference numbers as in FIG. 13. The auctioneer has the option, as described in the context of FIG. 12, to set an auction rule that blinds bidders 1402 who do not qualify to view the progress of the auction. The auctioneer has controls 1431 for resetting a round, starting a round, pausing a round or resuming it, ending a round, and proceeding to the next round. These are controls appropriate to an auctioneer and to a participant or bidder. In addition to the round history summary 1350 that the participants see, the auctioneer sees the total quantities bid in each round 1452 and the volume by which total bids exceed the minimum commitment 1454. The auctioneer also has a panel that lists bidders 1470. Each bidder is listed in a row. Their online/off-line status is indicated. Optionally, a credit limit applies to the bidder. Each bidder as an initial eligibility quantity. Based on the progress of the auction, a bidder also as a current eligibility and a current bid. Another panel indicates the status for observers who are neither controlling nor participating in the auction. The system optionally can be built to provide observers with round-by-round history information that includes all bids. An observer may be, for instance, an auction sponsor or a colleague of the auctioneer. The auctioneer's messages panel 1465 shows the auctioneer messages from all bidders and may translate bids into a narrative history. Messaging to the auctioneer interface may be handled by the message publisher 833 through a session queue 835 in the same manner as interactions are handled with participant interfaces, or it may be handled in a different way.

The system optionally can identify bidders with an arbitrary name, thereby depriving the auctioneer of any opportunity to favor one customer over another. This might be useful if the auction's sponsor were different than the auctioneer, or acting autonomously. The system could delay providing the auctioneer the identities of the winning bidders until an award was finalized. Alternatively, the auctioneer could be designated to close the auction, subject to ratification by the auctions sponsor, before the results would become final. Then, the auctioneer might never know the identities of the bidders, except if the auction's sponsor told the auctioneer. The system might be combined with any other features described.

FIG. 15 depicts a sample graph that can be used to project supply or demand curves and predict outcome of an auction as it progresses through several rounds. Many types of graphs could be used. A 3D ribbon graph is shown in this figure because the 3D presentation emphasizes the demand curves of individual participants b1-b6, while the ribbon prevents any participant's data from obscuring data from other participants' styles. (E.g., b3 obscuring b4 and b5.) The 2D analog of the ribbon graph is a line graph. It is particularly useful to the auctioneer for graphs of this sort to be updated in real time to enhance the auctioneer's or observer's understanding of the supply or demand among participants. Real time graphing does not have utility in other auction designs. The auction design disclosed herein uses shorter rounds and less time between rounds than other auctions—it is designed to run numerous, finely grained rounds without taking much of a participant's time.

Conventional, slower running auctions have taken a much different approach to granularity. For instance, Ausabel teaches in some applications that the auctioneer should elicit a supply or demand curve from bidders between auction rounds that fills in quantities that the participant would bid at prices in between prices set by the auctioneer in successive rounds. The effort required for bidders to provide supply or demand curve data is substantial. The prior art for improving granularity teaches away from running auction rounds very quickly. The pace at which conventional auctions run does not create any incentive to produce supply or demand graphs in real time. Conventional fixed quantity auctions or even auctions with a volume reduction rule can be run to conclusion without any need for an auctioneer to consider ending the auction early or “sweeping” the board. Conventional auctions do not give the auctioneer an agreed option to select an auction volume that exceeds a minimum volume commitment—the notion of a minimum volume commitment has not been found in the literature.

The utility of the real time graphs follows from the auctioneer's option to end the auction while the volume bid exceeds the minimum commitment. The auction sponsor or auctioneer repeatedly needs to decide whether to continue to another round or to close the auction. Participants have been observed holding their bids until the very end of an auction round, as the clock counts down close to zero, in order to test how long it takes for the auctioneer to start the next round. These participants assume that a 30 second pause between rounds for decision making, instead of a 15 second pause, indicates that the auction is nearing a final round. There is no consistent reason for the auctioneer to telegraph such information to participants. Accordingly, the very particular kind of auction disclosed creates an incentive to develop support for real time graphing to aid auctioneer decision making. This incentive is not present in conventional auctions.

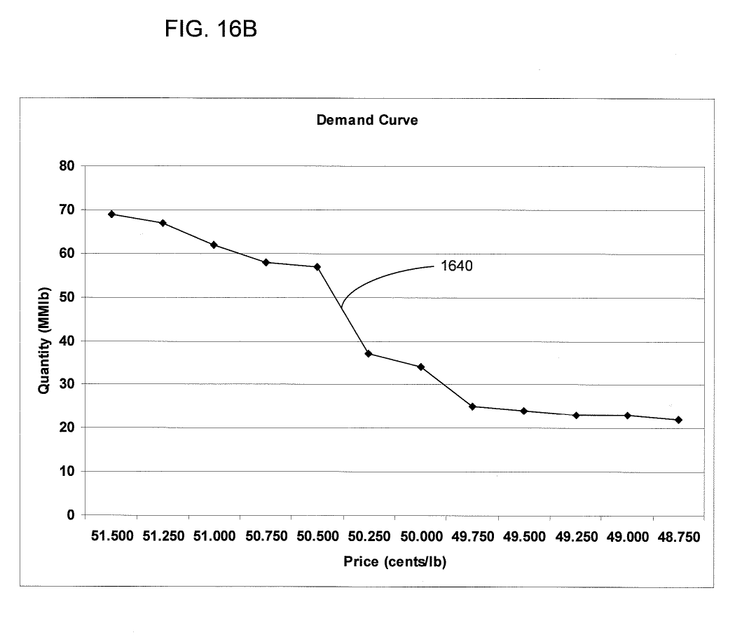

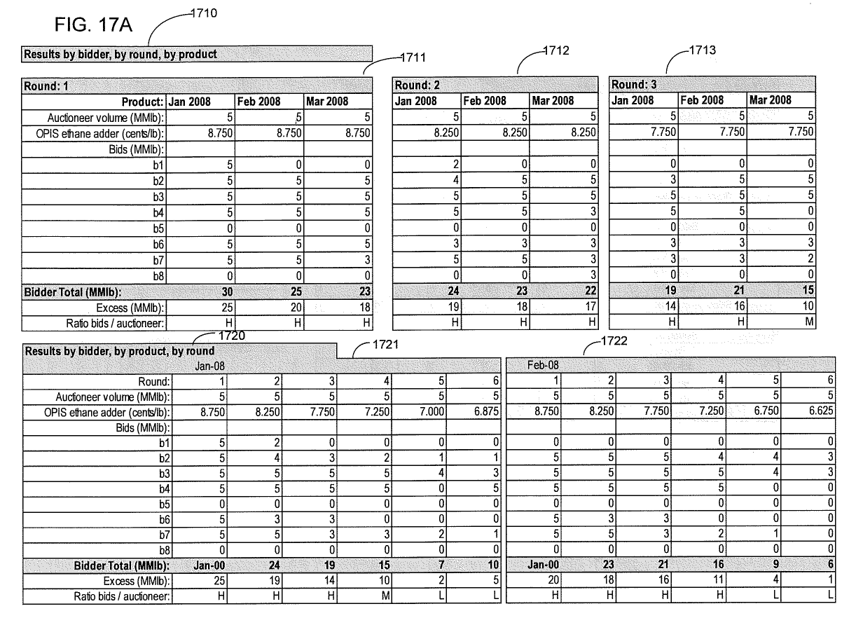

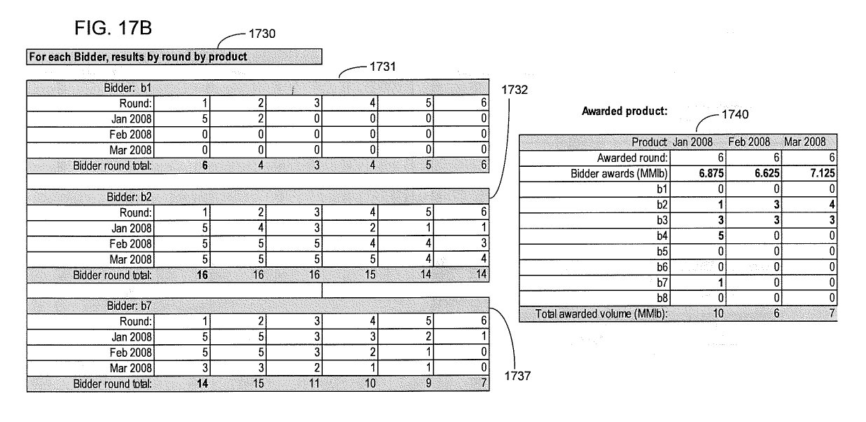

FIGS. 16-17 depict sample post-session reports that a auctioneer can provide to a session sponsor. In both FIGS. 16 and 17, a multi-round auction with a decreasing price is illustrated. FIG. 16 illustrates purchase of one product. FIG. 17 illustrates simultaneous purchase of three products, for delivery in successive months. In FIG. 16, three tables 1610, 1620, 1630 and one graph 1640 are provided. The tables provide a history by round 1610, a history by bidder 1620 and an auction allocation after the final round 1630. A history by round 1610 shows the auctioneer's price monotonically decreasing from 51.5 cents per pound to 48.75 cents per pound. The minimum commitment quantity is 10 million pounds. As the price offered decreases, the quantity offered by bidders decreases from 69 million to 22 million pounds. The demand indicator for demand in the range of 69 million pounds was “H”. Below 40 million pounds, the demand indication was “M”. The access column of this table indicates the difference between the total quantity offered and the minimum purchase commitment.

The history by bidder table 1620 provides the detail of participation by bidders b1-b7. For instance, bidder b2 offered to sell 3 million pounds in the first five rounds, until the price dropped to 50.25 cents per pound, at which point she dropped out. Bidder b1 initially offered to sell 20 million pounds and reduce the quantity offered to 10 million pounds before the auction closed.

The auction allocation table 1630 depicts the final award, in a case in which the auctioneer swept all offers made while the quantity offered was more than twice the minimum purchase commitment. Three winning bidders are identified as b1, b7 and b4. They are rank ordered by how quickly they made their bid, that is by timestamp, in the round before the final round. Alternatively, they could be ranked by timestamp in either the final round or in the round which is used for final pricing in the auction. Quantities are shown in separate columns for the amounts bid in the penultimate and final rounds of the auction. The final award, in this example, matches the quantity offered in the final round. The value of the transaction is extended by multiplying the final price by the final award quantity.

The demand curve 1640 provides a graphical representation of the total bidder demand shown in the history by round table 1610 and history by bidder table 1620. From the graph, it would appear that some sellers of the product at auction were relatively insensitive to the price offered.

FIG. 17 illustrates three auctions conducted simultaneously. The same substance was being auctioned, but it was treated as three different products because it was scheduled for delivery in three different months. The auction involved an ethane adder price, which corresponds to reactor time for refining capacity, as described above. This report includes two tables of results by bidder, one organized by round, by product 1710 and the other organized by product, by round 1720. The report also organizes the table by bidder 1730 and a product award table 1740. The first table 1710 is partially illustrated for three rounds. For each round, the three products for delivery in January through March, 2008 are listed in separate columns. Eight bidders participated. In round one 1711, the auctioneer's price for each product was 8.75 cents per pound refined, with a minimum purchase commitment of 5 million pounds per month. One can see that the auctioneer was buying capacity, because the price decreases from round to round. At the end of round one, 30 million pounds capacity was offered for January and lesser capacity was offered for February and March. For all three months, the capacity offered rated as “H”. In round two 1712, we see an anomaly. The auctioneer allowed bidder b8 to join the auction in the second round, even though no bid had been placed in the first-round. This might indicate that the bidder had communication problems of which the auctioneer was aware. Only three rounds of results are illustrated in table 1710, even though tables 1720, 1730, 1740 indicate that the auction went for six rounds.

The results by bidder, by product, by round table 1720 includes round-by-round results for January and February delivery of the product. All six rounds and all eight bidders are tallied. The point at which the quantity offered for January delivery dropped from “H” to “M” to “L” can be seen in the last row of the table.

The bidder results table 1730 shows results for one unsuccessful bidder 1731 and two successful bidders 1732, 1737. For each bidder, the results for all three products and the bids in all six rounds are depicted.

The product awarded table 1740 indicates which bidders were successful. The total awarded volume in the last row of the table shows that the minimum commitment was exceeded for all three products.

### WORKING EXAMPLES

The first example is from an auction in which this inventor was involved more than a year before filing of this application. The auction sponsor was selling ethylene. The seller initially committed to setting a starting price for the first round two days in advance of the auction, then changed to setting the starting price within 24 hours of the auction. Buyers at first were required to make binding initial offers one day in advance. The seller was not committed to sell any particular quantity. The seller had a private reserve price and assumed the right to begin bidding below the reserve price. Buyers were eligible to bid for up to the stated quantity offered. The initial round and subsequent rounds lasted three minutes, with the auctioneer reserving the right to change these durations. In case of trouble, participants were instructed to call auctioneer or the auctioneer. Demand indications of low, medium or high were given at the end of rounds. The change in price from round to round was tied to the demand indication, with different price increments for high, medium or low demand ratios. The auction was set to end when demand was less than or equal to the quantity offered. The software did not support any override of the closing rule. Participants who submitted initial offers as specified were entitled to see the results of all rounds of the auction.

The first working example did not include any minimum commitment from the auction sponsor. While the auction sponsor was allowed to decrease or increase the amount sold, there was no option for the auction sponsor to accept a different quantity at the end of the auction other than the quantity set for the final round. There was no option for the auction sponsor to sell a greater quantity than specified at the beginning of a round. There was no option for participants to offer more than the initially specified quantity.

The second example involves a recent auction sponsored by a buyer of ethylene, which is an embodiment of this disclosure. The buyer conducted three simultaneous but independent auctions for ethylene to be delivered in three successive months. Results of such an auction are illustrated in FIG. 17. Pricing was based on a so-called “adder” to average prevailing ethane prices for the months involved. The prevailing ethane prices could be discerned from published market prices available in the Oil Price Information Services bulletin. The buyer advertised a minimum commitment for purchase in each of the three auctions to prospective sellers two or three days in advance of the auction. No initial price was set until the auction and no pre-auction bids were required. The initial eligibility of sellers matched the minimum purchase commitment. The first round lasted five minutes with subsequent two minute rounds. The auctioneer monitored connections and latency. Demand indications of low, medium or high were given relative to the minimum purchase commitment. Price changes were at the auctioneer's discretion. The actual prices changed by one half, one quarter and then one eighth of a cent per round, over six rounds. The closure rule permitted the buyer to close the auction at any time and required the buyer to close the auction if the total of offers to sell was less than the minimum purchase commitment or if there was only one participant whose offer to sell equaled the minimum purchase commitment. This closure rule allowed the auction sponsor to subjectively optimize the volume in the auction by buying more than the minimum purchase commitment. The actual purchases varied from 1.2 to two times the minimum purchase commitment in the three simultaneous auctions. A limited visibility rule was applied, which restricted a participant from seeing the auction results for months and rounds, unless they had a valid minimum bid for those months and rounds. Volume eligibility was independently determined for the three auctions. Auction round results were not automatically available to participants registered or who made an initial minimum bid to sell ethylene in a particular month. Again, visibility was limited by auction to participants who had submitted a valid bid in the latest round of the particular auction.

The third example is a buyer's auction of ethylene for delivery within the next month at a price certain, not involving an adder. A minimum purchase commitment was advertised two or three days in advance of the auction and price set at the start of the auction. The third example differs from the first and second examples because participant initial eligibility was increased to twice the minimum purchase commitment. The price change from round to round was at the auctioneer's discretion. The price actually changed by one quarter of a cent per round and the auction went for 12 rounds. The buyer exercised a sweep option before the sum of offers dropped below the minimum purchase commitment. The buyer bought a little more than twice the minimum purchase commitment. Visibility was restricted to participants with a valid bid in the round.

The fourth example is the same as the third example, except for the visibility rule. In this auction, any participant who made an initial bid that met a minimum quantity was allowed to view auction rounds and final results, as if they were bidding in each round. The auction demonstrated the capability of the system to restart a round, when one participant became disconnected. It also demonstrated the impact of the high, medium and low indicators on bidding: demand was under-reported during the auction and the auction lasted only four rounds. Across those rounds, the price changed by only one-eighth of a cent per round and the final round produced a total quantity offered less than the minimum purchase commitment. The buyer swept the offers in the second to last round and purchased slightly more than the minimum purchase commitment.

The fifth example is a seller's auction of so-called PGP, produced from RPG. Pricing was based on market price of RPG plus an adder. In essence, buyers were purchasing from the auction sponsor so-called “cracker” time or refining capacity. A minimum commitment was advertised one day in advance of the auction and the price set at the beginning of the session. The initial buyer eligibility was set at three times the minimum purchase commitment. The visibility rule allowed any buyer who submitted a valid initial bid to view auction results.

Auctions following the format of the last four examples have produced surprisingly good results and met substantial commercial success. The results were much better than in auctions conducted in an eBay style or in auctions conducted by a live auctioneer. In fact, an eBay style auctioneer attempted to preempt auctions conducted by this inventor by scheduling competing auctions for one hour before the inventor's auctions. The other auctioneer was surprised that the eBay styled auctions failed and disclosed style of auction was very successful. The eBay style auctions are no longer conducted for ethylene. Live auctions of spot quantities of ethylene also have lost favor as the model disclosed in this application has gained acceptance. Within the months before filing of this application, there was a dramatic increase in demand for the style of auctions disclosed in this application.

### SOME PARTICULAR EMBODIMENTS

The present invention may be practiced as a method or device adapted to practice the method. The same method can be viewed from the perspective of the server from which the auction is run, the participant computer that is participating in the auction or an observer who is watching the interaction between the various computers. The invention may be an article of manufacture such as storage media impressed with logic to carry out computer-implemented auction involving participants at various locations.

The first embodiment is from the perspective of a server used to implement an auction. It is a method of using a computer to implement an auction of a divisible quantity of an item, with two or more participants participating in the auction by indicating the quantity in which they are interested. The auction permits an auctioneer or auction sponsor to accept bids from the participants in quantities that exceed a minimum commitment announced before the auction. This option allows the auction sponsor to subjectively optimize the volume of bids accepted in the auction while assuring the participants of a meaningful volume. This embodiment is stated symmetrically, so that it applies both to an auction sponsored by a seller (a so-called forward auction) and to an auction sponsored by a buyer (a so-called reverse auction).

The method optionally begins with transmitting to a plurality of participants a program to be run on participant computer systems. The program is adapted to display a countdown of time remaining in an auction round, to display a round price, a minimum commitment applicable to the auction and a quantity eligibility of a particular in the auction round. The program is further adapted to forward from the particular participant's computer system to an auctioneer's computer system a bid quantity. Optionally, the bid quantity is limited by the auction rules or by controls that are part of the program.

The first embodiment method includes transmitting to the participants a minimum commitment applicable to the auction and starting a round by transmitting to the participant's computer systems a round price and a round duration. The method includes receiving from interested participants' programs their bids of quantities at the round price. Then, evaluating the bids received from the interested participants' programs and selecting among choices that include at least: (1) halting the bidding if the total quantities of the bids do not satisfy the minimum commitment; (2) halting the bidding of the auctioneer decides to accept all the quantities offered; or (3) adjusting the quantity eligibility of the participants to match the quantity in their bids, transmitting to the participants' computer systems of mass indication of total quantities bid relative to the minimum commitment, and proceeding to an additional round by repeating the starting, receiving and evaluating actions.

A variety of aspects and features can be combined with this symmetrically stated method or with methods that are stated from the perspective of a buyer or seller. This variety of aspects and features often apply regardless of whether the embodiment is described from the perspective of a server hosting the auction or a participant's computer system that is participating in the auction. They also apply to methods, storage media including program instructions to implement methods or computer systems running programs to implement methods.

One aspect applicable to the various embodiments is to further include, when evaluating the bids received in the second and subsequent rounds, if the total of the quantities bid in the round is less than the minimum commitment, reverting to the round price in the quantities bid in the immediately preceding round without reducing the minimum commitment. Allocation of quantities among participants may be according to the immediately preceding round or it may give priority and allocation to participants participating and quantities bid in the round that produced bids totaling less than the minimum commitment. We note that the minimum commitment is not reduced simply because the total of quantities bid in the round drops below the minimum commitment. Maintaining the minimum commitment helps secure participation in the auction.

In combination with the first aspect or by itself, this method may include the auctioneer choosing a quantity of bids to accept that is greater than the minimum commitment and less than or equal to the total of quantities bid in the closing round.

A feature of the masked indication of the quantities bid relative to the minimum commitment may be that demand indicators include at least “high,” “medium” and “low” indications. A legend that defines how ranges of the total quantities bid in a round will be reported may be supplied to the participants to improve their understanding of the masked indication.

The methods, programs devices disclosed enable rounds be run quickly with relatively smaller price variations between rounds than are practical when rounds last an extended time. In one variation, a first-round has an extended duration and second and subsequent rounds have durations of 15 to 120 seconds. In another variation, a registration period precedes bidding rounds and the bidding rounds have durations of five to 90 seconds. In an ethylene auction, for instance, a quantity of 10 million pounds may be bid with a value approaching $5 million. With bidding rounds the last just 60 to 90 seconds, it is practical to adjust the price by ⅛ or 1/16 of a cent each round. These fine price gradations work to the advantage of the auction sponsor.

Another feature that may be combined with various embodiments further includes transmitting to a particular participant's computer system a history of the particular participant's eligibility, quantity bid and extended price for the quantity bid, and the masked indication of the quantities bid on a round by round basis, until the particular participant is no longer eligible to receive updates. Alternatively, using Ajax, flax or a similar technology, data may be transmitted incrementally to the participant's computer system and displayed in a cumulative table.

Eligibility of a participant to continue receiving updates may be determined in at least three alternative ways. Participants who register for the auction and attend a first-round may be eligible through all rounds the auction to see the round price and the masked indication of quantities bid. These participants may be entitled to see the closing result of a final round price and bid quantities accepted. Second, participants to make a valid bid in the first round may be eligible through all rounds and to see final information. Or, access to updated information regarding the round price, the masked indication of the quantities bid and a closing result may be limited to just those participants who have made a valid bid in an immediately preceding round. If multiple auctions are conducted simultaneously, visibility of auction results may depend on valid participation in each of the particular auctions.

An aspect of the program interface transmitted to participants is that it may simultaneously display multiple auctions that are conducted concurrently. A longer round duration, up to five minutes, may be supported to give participants a chance to place bids in each of the auctions.

The program transmitted to participants may be further adapted to accept or confirm entry by the participant of the bid quantity using a control that visually confirms a magnitude of the bid quantity. This kind of control makes readily apparent any error resulting from a mistaken number of zeroes in the bid quantity. Examples of visually confirming controls include a slider, a dial and a series of radio buttons.

A second embodiment restates the first embodiment from the perspective of a participant's computer system. This method includes receiving from an auctioneer's system a program to run on the participant system. The program is adapted to display a countdown of time remaining in an auction round, to display a round price, minimum commitment applicable to the auction, and a quantity eligibility of the particular participant in the auction round. The program is further adapted to forward from the participant's computer system to the auctioneer's computer system the bid quantity. The method further includes receiving from the auctioneer system the minimum commitment applicable to the auction. When a round starts, it includes receiving a round price in a round duration, then transmitting to the auctioneer system the bidders bid quantities at the round price. During second and subsequent rounds, the method includes receiving a masked indication of total quantities bid relative to the minimum commitment and information for the second and subsequent rounds. After two or more rounds, the method includes receiving results from the auctioneer system that close the auction with acceptance of total quantities bid that at least satisfy the minimum commitment. Receiving results from the auctioneer leaves open the option for the auctioneer to announce acceptance of bids that exceed the minimum commitment. When the results are received from the auctioneer, the latest round in which the total quantity bid was greater than or equal to the minimum commitment is announced and bid quantities are extended at a price corresponding to that latest round.

In general, each aspect in variation applicable when the embodiment is stated from the perspective of the auctioneer's computer system or the server hosting the auction applies equally when the embodiment is stated from the perspective of the participant's computer system. These aspects include how the masked indication is reported, linking the masked indication to legend, round durations, bidding history information, blinding participants who are not eligible to see certain history information, and using visual controls to avoid or make readily apparent mistyping of bid quantities.

Another embodiment is an article of manufacture, including a storage medium containing program instructions adapted to implement an auction of a divisible quantity. Two variations on this embodiment are the program that runs on the participant's computer systems and the program that runs on the auctioneer's computer system. The program running on the auctioneer's computer system optionally includes provision for transmitting to a plurality of participants the program that runs on the participant computer systems.

A related embodiment is a method of enabling a workstation to implement an auction of a divisible quantity of an item. Two variations on this embodiment are transmitting to a workstation a program adapted to carry out the auction server method embodiment described above and transmitting to a workstation a program adapted to carry out the participant side of the auction method described above.

The symmetrical embodiment can be restated alternatively as a buyer's auction or a seller's auction. From a buyer's perspective, another embodiment is a method of using a computer to implement a buyer's auction of a divisible quantity of an item, with two or more participants participating in the auction by indicating a quantity that they are willing to sell at a stated price. This auction design permits the auctioneer to accept bids from the participants that equal or exceed a minimum purchase commitment announced before the auction.

Optionally, the method includes transmitting to a plurality of participants a program to be run on participants' computer systems. The program is adapted to display a countdown of time remaining in an auction round, to display a round price, minimum purchase commitment applicable to the auction and a quantity eligibility of a particular participant in the auction round. The program is further adapted to forward from the particular participant's computer system to an auctioneer's computer system a bid quantity.

The method includes transmitting to the participants the minimum purchase commitment applicable to the auction and starting a first-round by transmitting to the participants' computer systems a first round price, round duration and a first-round participant quantity eligibility. The method includes receiving from interested participants' computer systems bids of quantities for sale at the first round price made before expiration of the round duration. It includes evaluating the bids received and, if a total of the quantities for sale exceeds the minimum purchase commitment, deciding whether to accept the bids received or to continue to the next round.

In second and subsequent rounds, the method includes transmitting to at least some of the participants a masked indication of the total quantities bid for sale in the immediately preceding round, adjusting the participants eligibilities to equal their bid in the immediately preceding round and repeating until bids are accepted, transmitting of a new round price and an adjusted participant quantity eligibility, the receiving of bid quantities at the new round price and the evaluating of the bids received from the interested participants.

The aspects and variations applicable to the symmetrical embodiment above also apply to the buyer's auction embodiment. Some additional aspects of this technology can be more concretely stated with respect to a buyer's auction than with respect to a symmetrical embodiment.

One aspect of the buyer's auction is that it may further include, when evaluating the bids received from the interested participants in the second and subsequent rounds, if the total of the quantities bid in the round is less than the minimum purchase commitment, referred to in the round price and the quantities bid in the immediately preceding round without reducing the minimum purchase commitment. According to one variation on this aspect, the auctioneer chooses a quantity to buy that is greater than the minimum purchase commitment and less than or equal to the total of the quantities bid in the immediately preceding round. When the auctioneer decides to buy all of the quantities bid in the immediately preceding round, we refer to that as sweeping the bids.

Another aspect that is particular to a participant's auction is when the participants have different delivery modes for the item being auctioned. At least one participant's large delivery mode involves a minimum economical delivery quantity. This variation further includes setting the minimum purchase commitment to half or less of the large delivery mode minimum economical delivery quantity and setting the first round participant quantity eligibility to equal or exceed the large delivery mode minimum economical delivery quantity. In some auctions, it is anticipated that both domestic and foreign participants will participate. Domestic participants may use tank cars and railways for delivery or pipelines. The international participants may use shiploads. And economical shipload quantity may be three times as large as domestic participants are interested in selling. Accordingly, the first-round participant eligibility may be three or more times the minimum purchase commitment. Stated more generally, another variation includes setting the minimum purchase commitment to less than the large delivery mode minimum economical delivery quantity and setting the first-round participant quantity eligibility to exceed the large delivery mode minimum economical delivery quantity.

From a seller's perspective, another embodiment is a method of using a computer to implement a seller's auction of a divisible quantity of an item, with two or more participants participating in the auction by indicating a quantity that they are willing to buy at a stated price. This auction design permits the auctioneer to accept bids from the participants that equal or exceed a minimum sales commitment announced before the auction.

Optionally, the method includes transmitting to a plurality of participants a program to be run on participants' computer systems. The program is adapted to display a countdown of time remaining in an auction round, to display a round price, minimum sales commitment applicable to the auction and a quantity eligibility of a particular participant in the auction round. The program is further adapted to forward from the particular participant's computer system to an auctioneer's computer system a bid quantity.

The method includes transmitting to the participants the minimum sales commitment applicable to the auction and starting a first-round by transmitting to the participants' computer systems a first round price, round duration and a first-round participant quantity eligibility. The method includes receiving from interested participants' computer systems bids of quantities to be purchased at the first round price made before expiration of the round duration. It includes evaluating the bids received and, if a total of the quantities to be purchased exceeds the minimum sales commitment, deciding whether to accept the bids received or to continue to the next round.

In second and subsequent rounds, the method includes transmitting to at least some of the participants a masked indication of the total quantities bid to be purchased in the immediately preceding round, adjusting the participants' eligibilities to equal their bid in the immediately preceding round. It includes repeating until bids are accepted: transmitting of a new round price and an adjusted participant quantity eligibility, the receiving of bid quantities at the new round price and the evaluating of the bids received from the interested participants.

The aspects and variations applicable to the symmetrical embodiment above also apply to the seller's auction embodiment. Some additional aspects of this technology can be more concretely stated with respect to a seller's auction than with respect to a symmetrical embodiment.

One aspect of the seller's auction is that it may further include, when evaluating the bids received from the interested participants in the second and subsequent rounds, if the total of the quantities bid in the round is less than the minimum sales commitment, reverting to the round price and the quantities bid in the immediately preceding round without reducing the minimum sales commitment. According to one variation on this aspect, the auctioneer chooses a quantity to sell that is greater than the minimum sales commitment and less than or equal to the total of the quantities bid in the immediately preceding round. When the auctioneer decides to sell to satisfy all of the quantities bid in the immediately preceding round, we refer to that as sweeping the bids.

Another aspect that is particular to a participant's auction is when the participants have different delivery modes for the item being auctioned. At least one participant's large delivery mode involves a minimum economical delivery quantity. This variation further includes setting the minimum sales commitment to half or less of the large delivery mode minimum economical delivery quantity and setting the first round participant quantity eligibility to equal or exceed the large delivery mode minimum economical delivery quantity. In some auctions, it is anticipated that both domestic and foreign participants will participate. Domestic participants may use tank cars and railways for delivery or pipelines. The international participants may use shiploads. And economical shipload quantity may be three times as large as domestic participants are interested in selling. Accordingly, the first-round participant eligibility may be three or more times the minimum sales commitment. Stated more generally, another variation includes setting the minimum sales commitment to less than the large delivery mode minimum economical delivery quantity and setting the first-round participant quantity eligibility to exceed the large delivery mode minimum economical delivery quantity.

Another embodiment describes a computer auction server, generally along the lines depicted in FIG. 8. This computer auction device includes a processor and memory coupled to the processor. It includes a request queue in memory adapted to receive messages from the auction clients, including bids and text messages. It includes one or more response queues in memory adapted to hold updated information to be transmitted auction clients. It further includes a processing module, running on a processor, adapted to handle various events during an auction. The processing module is adapted to update the response queues, including providing a minimum commitment at the outset of the auction and, for rounds in the auction, providing a round duration, a round price and a massed demand indicator. The massed offers indicator applies in second and subsequent rounds, as no offers have been made prior to the first round. The processing module handles incoming bid quantities at the round price and handles incoming text messages. It handles auctioneer decisions and updates an auctioneer's dashboard that displays status information for the auction. In this embodiment, the decision options available to the auctioneer include closing the auction while a total of incoming quantities offered exceeds the minimum commitment. This option allows the auctioneer to accept all of the incoming offers and to close the auction when the transaction volume exceeds the minimum commitment.

One aspect of this device involves a request queue shared among the auction participants or clients and particular response queues allocated to particular auction participants or clients. In this way, messages from the clients are serialized in the order received and messages to the clients can be processed on multiple threads, either pushed to auction client software or provided in response to periodic polling by auction client software.

Another aspect of this device involves the processing module serializing the handling of income offer quantities and updating the response queues. It further includes multiple threads of response queue handlers that respond to polling requests from the auction clients and transmit updated information from particular response queues to particular auction clients.

The technology disclosed can usefully be practiced as an article of manufacture, which can be used to build the device or practice a method. This embodiment includes an article of manufacture, including a storage media containing program instructions adapted to implement an auction of a divisible quantity of an item, with two or more participants in the auction who indicate the quantity in which they are interested. The auction rules permit the auctioneer to accept bids from the participants that exceed the minimum commitment announced before the beginning of the auction. The program instructions are adapted to transmitting to the participants a minimum commitment applicable to the auction and starting a round by transmitting to the participant's computer systems a round price and a round duration. The method includes receiving from interested participants' programs their bids of quantities at the round price. Then, evaluating the bids received from the interested participants' programs and selecting among choices that include at least: (1) halting the bidding if the total quantities of the bids do not satisfy the minimum commitment; (2) halting the bidding if the auctioneer decides to accept all the quantities offered; or (3) adjusting the quantity eligibility of the participants to match the quantity in their bids, transmitting to the participants' computer systems a mass indication of total quantities bid relative to the minimum commitment, and proceeding to an additional round by repeating the starting, receiving and evaluating actions.

The method aspects and features described above can be combined into this article of manufacture.

Another article of manufacture embodiment includes a storage media containing program instructions adapted to implement and manage request and response queues, to handle incoming bid quantities at a round price, handle incoming text messages, handle auctioneer decisions and update an auctioneer's dashboard with status information, as described in the device embodiment above. The program instructions of this article of manufacture make available to the auctioneer decision options including an option to close an auction while the incoming quantities offered exceed the minimum commitment, thereby allowing the auctioneer to accept all incoming offers and, at least subjectively, optimize the auction volume.

Alternatively, the technology disclosed can usefully be practiced as a method of enabling a workstation to implement any of the auction methods described above. This method includes a server transmitting to a workstation program instructions to be run on the workstation adapted in two parts for transmitting interfaces to client systems and for implementing a server system. The program instructions for transmitting interfaces to client systems include instructions for transmitting to a plurality of participants a program to be run on participants' computer systems. The interface program is adapted to display a countdown of time remaining in an auction round, display a round price, minimum commitment applicable to the auction, and the quantity eligibility of a particular participant in the auction round. It further is adapted to forward from the particular participant's computer system to an auctioneer's computer system a bid quantity. The program instructions for implementing a server system include instructions for transmitting to the participants a minimum commitment applicable to the auction and starting a round by transmitting to the participants' computer systems a round price at a round duration. These server program instructions are further adapted for receiving from interested participants' programs their bids of quantities at a round price and evaluating the bids received from the interested participants' programs and selecting among auctioneer options. The auctioneer options include at least: holding the bidding, if the total quantities of the bids do not satisfy the minimum commitment; holding the bidding if the auctioneer decides to accept all of the quantities offered; or, adjusting the quantity eligibility so the participants to match the quantity in their bids, transmitting to the participants' computer systems amassed indication of quantities bid relative to the minimum commitment (or to the first-round bid eligibility), and proceeding to an additional round by repeating the starting, receiving and evaluating actions.

Transmitting these program instructions to a workstation is a useful step in building a workstation that can practice the method described or that can become the device described above. It is a practical way of building a system. It is an important and tangible method of distributing program instructions, which developers find even more convenient than receiving optical media. The program instructions transmitted are functional, because they are intended to control the workstation, once they have been received and are installed on the workstation.

The method aspects and features described above can be combined into this method of enabling a workstation to implement an auction of a divisible quantity of an item.

Another method of enabling a workstation to implement an auction of a divisible quantity of an item includes a server transmitting to a workstation program instructions to be run on the workstation adapted to implement and manage request and response queues, to handle incoming bid quantities at a round price, handle incoming text messages, handle auctioneer decisions and update and auctioneer's dashboard status information, as described in the device embodiment above. The program instructions transmitted by this method make available to the auctioneer decision options including an option to close an auction when the incoming quantities offered exceed the minimum commitment, thereby allowing the auctioneer to accept all incoming offers and, at least subjectively, optimize the auction volume.

As described above, this method of transmitting instructions as a step in building a workstation is useful, practical and tangible. It can be practiced with any of the aspects and features of the methods and devices described above.

We claim as follows:

1. A method using a computer to implement an auction of a divisible quantity of an item, with two more participants in the auction by indicating the quantity in which they are interested, the auction permitting the auctioneer to accept bids from the participants that exceed a minimum commitment announced before or at the beginning of the auction, the method including:
transmitting to a plurality of participants a program to be run on participant computer systems, which said program is adapted
to display a countdown of time remaining in an auction round,
to display a round price, a minimum commitment applicable to the auction, and a quantity eligibility of a particular participant in the auction round, and
to forward from the particular participant's computer system to an auctioneer's computer system a bid quantity;
transmitting to the participants the minimum commitment applicable to the auction;
starting a round by transmitting to the participants' computer systems a round price and a round duration;
receiving from interested participants' programs their bids of quantities at the round price;
evaluating the bids received from the interested participants' programs and selecting among choices that include at least
halting the bidding if the total quantities of the bids do not satisfy the minimum commitment,
halting the bidding if the auctioneer decides to accept all of the quantities offered, or
adjusting the quantity eligibilities of the participants to match the quantity in their bids, transmitting to the participants' computer systems a masked indication of quantities bid relative to the minimum commitment, and proceeding to an additional round by repeating the starting, receiving and evaluating actions.

2. The method of claim 1, further including, when evaluating the bids received in second and subsequent rounds, if the total of the quantities bid in the round is less than the minimum commitment, reverting to the round price and the quantities bid in the immediately preceding round without reducing the minimum commitment.

3. The method of claim 2, wherein an auction sponsor chooses a quantity of bids to accept that is greater than the minimum commitment and less than or equal to the total of the quantities of the bids in the immediately preceding round.

4. The method of claim 1, wherein the masked indication of the quantities bid relative to the minimum commitment includes at least high, medium and low demand indicators.

5. The method of claim 4, further including transmitting to the participants a legend that defines how ranges of the total of the quantities bid in a round will be reported by the high-medium-low demand indicators.

6. The method of claim 1, wherein a first round has an extended duration and second and subsequent rounds have durations 15 to 120 seconds.

7. The method of claim 1, wherein a registration period precedes bidding rounds and first, second and subsequent rounds have durations of 5 to 90 seconds.

8. The method of claim 1, further including transmitting to a particular participant's computer system a history of the particular participant's eligibility, quantity bid and extended price for the quantity bid, and the masked indication of the quantities bid on a round-by-round basis, until the particular participant is no longer eligible to receive updates.

9. The method of claim 8, wherein the participants who register for the auction and attend a first round are eligible through all rounds to see the round price, the masked indication of the quantities bid and a closing result of bid quantities accepted.

10. The method of claim 8, wherein the participants who make a valid bid in the first round are eligible through all rounds to see the round price, the masked indication of the quantities bid and a closing result of bid quantities accepted.

11. The method of claim 8, wherein access to updated information regarding the round price, the masked indication of the quantities bid and a closing result of bid quantities accepted requires that a particular participant have made a valid bid in an immediately preceding round.

12. The method of claim 1, wherein the program is further adapted to accept or confirm entry by the participant of the bid quantity using a control that visually confirms a magnitude of the bid quantity, whereby errors resulting from a mistaken number of zeros in the bid quantity are readily apparent.

13. The method of claim 12, wherein the visually confirming control is a slider.

14. The method of claim 12, wherein the visually confirming control is a dial.

15. The method of claim 12, wherein the visually confirming control is a series of radio buttons.

16. The method of claim 1, wherein the program is further adapted to display a state transition diagram that depicts the current state of the round and of the auction overall.

17. A computer auction device in communication with multiple auction clients, including:
a processor;
memory coupled to the processor;
a request queue in the memory adapted to receive messages from the auction clients, including bids and text messages;
one or more response queues in the memory adapted to hold updated information to be transmitted to the auction clients;
a processing module, running on the processor, adapted to:
update the response queues, including providing a minimum commitment at the outset of the auction and, for rounds in the auction, providing a round duration, a round price and a masked bids indicator (for second and subsequent rounds);
handle incoming bid quantities at the round price;
handle incoming text messages;
handle auctioneer decisions; and
update an auctioneer's dashboard that displays status information for the auction; and
wherein the auctioneer decisions available include options to close the auction while a total of the incoming bid quantities exceeds the minimum commitment and to accept all of the incoming bids.

18. The device of claim 17, wherein the request queue is shared among the auction clients and a particular response queue is allocated to a particular auction client.

19. The device of claim 17, wherein the processing module serializes the handling of the incoming bid quantities and the updating the response queues, further including multiple threads of response queue handlers that respond to polling requests from the auction clients and transmit updated information from particular response queues to particular auction clients.

20. An article of manufacture, including a storage media containing program instructions adapted to implement an auction of a divisible quantity of an item, with two more participants in the auction by indicating the quantity in which they are interested, the auction permitting the auctioneer to accept bids from the participants that exceed a minimum commitment announced before or at the beginning of the auction, including:
transmitting to a plurality of participants a program to be run on participant computer systems, which said program is adapted
to display a countdown of time remaining in an auction round,
to display a round price, a minimum commitment applicable to the auction, and a quantity eligibility of a particular participant in the auction round, and
to forward from the particular participant's computer system to an auctioneer's computer system a bid quantity;
transmitting to the participants the minimum commitment applicable to the auction;
starting a round by transmitting to the participants' computer systems a round price and a round duration;
receiving from interested participants' programs their bids of quantities at the round price;
evaluating the bids received from the interested participants' programs and selecting among choices that include at least
halting the bidding if the total quantities of the bids do not satisfy the minimum commitment,
halting the bidding if the auctioneer decides to accept all of the quantities offered, or
adjusting the quantity eligibilities of the participants to match the quantity in their bids, transmitting to the participants' computer systems a masked indication of quantities bid relative to the minimum commitment, and proceeding to an additional round by repeating the starting, receiving and evaluating actions.

21. A method of enabling a workstation to implement an auction of a divisible quantity of an item, with two more participants in the auction by indicating the quantity in which they are interested, the auction permitting the auctioneer to accept bids from the participants that exceed a minimum commitment announced before or at the beginning of the auction, the method including:
transmitting to the workstation a program adapted to carry out the following actions:
transmitting to a plurality of participants a program to be run on participant computer systems, which said program is adapted
to display a countdown of time remaining in an auction round,
to display a round price, a minimum commitment applicable to the auction, and a quantity eligibility of a particular participant in the auction round, and
to forward from the particular participant's computer system to an auctioneer's computer system a bid quantity;
transmitting to the participants the minimum commitment applicable to the auction;
starting a round by transmitting to the participants' computer systems a round price and a round duration;
receiving from interested participants' programs their bids of quantities at the round price;
evaluating the bids received from the interested participants' programs and selecting among choices that include at least
halting the bidding if the total quantities of the bids do not satisfy the minimum commitment,
halting the bidding if the auctioneer decides to accept all of the quantities offered, or
adjusting the quantity eligibilities of the participants to match the quantity in their bids, transmitting to the participants' computer systems a masked indication of quantities bid, and proceeding to an additional round by repeating the starting, receiving and evaluating actions

22. A method using a computer to implement a buyer's auction of a divisible quantity of an item, with two more participants in the auction by indicating the quantity that they are willing to sell at a stated price, the auction permitting the auctioneer to accept bids from the participants that equal or exceed a minimum purchase commitment announced before the auction, the method including:
transmitting to a plurality of participants a program to be run on participant computer systems, which said program is adapted
to display a countdown of time remaining in an auction round,
to display a round price, a minimum purchase commitment applicable to the auction, and a quantity eligibility of a particular participant in the auction round, and
to forward from the particular participant's computer system to an auctioneer's computer system a bid quantity;
transmitting to the participants the minimum purchase commitment applicable to the auction;
starting a first round by transmitting to the participant's computer systems a first round price, a round duration and a first round participant quantity eligibility;
receiving from interested participants' computer systems bids of quantities for sale at the first round price made before expiration of the round duration;
evaluating the bids received and, if a total of the quantities for sale exceeds the minimum purchase commitment, deciding whether to accept the bids received or to continue to a next round; and
in second and subsequent auction rounds, transmitting to at least some of the participants a masked indication of the total quantities bid for sale in the immediately preceding round, adjusting the participants' eligibilities to equal their bid in the immediately preceding round, and repeating until bids are accepted:
the transmitting of a new round price and an adjusted participant quantity eligibility,
the receiving of bid quantities at the new round price, and
the evaluating of the bids received from the interested participants.

23. The method of claim 22, further including, when evaluating the bids received from the interested participants in the second and subsequent rounds, if the total of the quantities bid in the round is less than the minimum purchase commitment, reverting to the round price and the quantities bid in the immediately preceding round without reducing the minimum purchase commitment.

24. The method of claim 23, wherein an auction sponsor chooses a quantity to buy that is greater than the minimum purchase commitment and less than or equal to the total of the quantities of the bids in the immediately preceding round.

25. The method of claim 22, wherein the first round has an extended duration for participants and the second and subsequent rounds have durations of 30 to 150 seconds.

26. The method of claim 22, wherein a registration period precedes bidding rounds and the first, second and subsequent rounds have durations of 5 to 90 seconds.

27. The method of claim 22, further including transmitting to a particular participant's computer system a history of the particular participant's eligibility, quantity bid and extended price for the quantity bid, and the masked indication of the quantities bid on a round-by-round basis, until the particular participant is no longer eligible to receive updates.

28. The method of claim 22, wherein the participants have different delivery modes for the item and at least one participant's large delivery mode involves a minimum economical delivery quantity, further including:
setting the minimum purchase commitment to half or less of the large delivery mode minimum economical delivery quantity; and
setting the first round participant quantity eligibility to equal or exceed the large delivery mode minimum economical delivery quantity for at least one participant.

29. The method of claim 22, wherein the participants have different delivery modes for the item and at least one participant's large delivery mode involves a minimum economical delivery quantity, further including:
setting the minimum purchase commitment to less than the large delivery mode minimum economical delivery quantity; and
setting the first round participant quantity eligibility to exceed the large delivery mode minimum economical delivery quantity.

30. A method using a computer to implement a seller's auction of a divisible quantity of an item, with two more participants in the auction by indicating the quantity that they are willing to buy at a stated price, the auction permitting an auction sponsor to accept bids from the participants that equal or exceed a minimum sales commitment announced before the auction, the method including:
transmitting to a plurality of participants a program to be run on participant computer systems, which said program is adapted
to display a countdown of time remaining in an auction round,
to display a round price, a minimum sales commitment applicable to the auction, and a quantity eligibility of a particular participant in the auction round, and
to forward from the particular participant's computer system to an auctioneer's computer system a bid quantity;
transmitting to the participants the minimum sales commitment applicable to the auction;
starting a first round by transmitting to the participant's computer systems a first round price, a round duration and a first round participant quantity eligibility;
receiving from interested participants' computer systems bids of quantities to be purchased at the first round price, the bids made before expiration of the round duration;
evaluating the bids received and, if a total of the quantities for sale exceeds the minimum sales commitment, deciding whether to accept the bids received or to continue to a next round; and
in second and subsequent auction rounds, transmitting to at least some of the participants a masked indication of the total quantities bid to be purchased in the immediately preceding round, adjusting the participants' eligibilities to equal their bid in the immediately preceding round, and repeating until bids are accepted:
the transmitting of a new round price and an adjusted participant quantity eligibility,
the receiving of bid quantities at the new round price, and
the evaluating of the bids received from the interested participants.

31. The method of claim 22, further including, when evaluating the bids received from the interested participants in the second and subsequent rounds, if the total of the quantities bid in the round is less than the minimum purchase commitment, reverting to the round price and the quantities bid in the immediately preceding round without reducing the minimum purchase commitment.

32. The method of claim 23, wherein an auction sponsor chooses a quantity to buy that is greater than the minimum purchase commitment and less than or equal to the total of the quantities of the bids in the immediately preceding round.

33. The method of claim 22, wherein the first round has an extended duration for participants and the second and subsequent rounds have durations of 30 to 150 seconds.

34. The method of claim 22, wherein a registration period precedes bidding rounds and the first, second and subsequent rounds have durations of 5 to 90 seconds.

35. The method of claim 2, further including transmitting to the participants a legend that defines how ranges of the total of the quantities for sale in a round will be reported by the high-medium-low demand indicators.

36. The method of claim 2, further including transmitting to a particular participant's computer system a history of the particular participant's eligibility, quantity bid and extended price for the quantity bid, and the masked indication of the quantities bid on a round-by-round basis, until the particular participant is no longer eligible to receive updates.

37. The method of claim 22, wherein the program is further adapted to accept or confirm entry by the participant of the bid quantity using a control that visually confirms a magnitude of the bid quantity, whereby errors resulting from a mistaken number of zeros in the bid quantity are readily apparent.
